(19) United States
(12) Patent Application Publication
(10) Pub. No.: US 2026/0350684 A1
(43) Pub. Date: Nov. 5, 2026

(54) Revolutionary, disruptive, redefining, and changing modern business rules,modern macroeconomics, modern microeconomics, process of human being civilization and human being civilization’s way or the method and the method or model or the platform created to implement this method

(71) Applicant: CHUANPING HU, PITTSBURG, KS (US)

(72) Inventor: CHUANPING HU, PITTSBURG, KS (US)

(21) Appl. No.: 19/196,378

(22) Filed: May 1, 2025

(51) Int. Cl. G06Q 30/0601; G06Q 40/06

(52) U.S. Cl. CPC G06Q 30/0631; G06Q 40/0631

(57) ABSTRACT

This method, platform or patent is planned economy under a market economy, eliminates random or blind production by factories and random or blind consumption by consumers and supply according to demand all people in the world from birth to death with the best product, goods, and service quality and the lowest prices through “non-retail” in a nontraditional sense, “no fixed cost expenses such as bank interest required by typical businesses,”
“eliminating random or blind production by manufacturers and consumption by consumers,” “thoroughly eliminating waste in the production and consumption process,” “substituting, eliminating, and thoroughly eliminating inefficient small, medium, large, and even huge enterprises in every industry for every product, commodity, or service,” “consumers being able to buy the best quality, lowest price, and best value products, commodities, or services in the world,” “saving people's time and money in consumption,” “helping the poor and reducing poverty,” “green and low-carbon,” “helping to address global climate change,” and so on. Therefore, this method, this platform, and this patent change the way people work and live, as well as the way enterprises produce products in the production process.

This patent represents a revolutionary and disruptive redefinition, reshaping, and replacement of modern economic theory, including micro and macroeconomics, since the patent changes, replaces, disrupts, redefines, and reshapes modern business rules and revolutionizes and redefines the course of human civilization and human civilization itself.

This method will establish a wave that includes Industry 4.0 or 5.0, and transform manufacturing into a service industry this method eliminates the traditional concept of primary, secondary, and tertiary industries and merge into one.

Producers under the method or patent have no advertising expenses, no sales expenses or costs, and no market expenses or costs even no financial costs, This method's revolutionary and transformative reshaping and redefining of the traditional financial industry, especially the banking sector, and human social and economic activities. This method will help and serve almost all consumers from birth to near-death around the world save time and money, optimize the way they spend their money, helps poor people and reduces the poverty rate, eliminates waste in various industries from production to consumption, therefore, is environmentally friendly and low-carbon and effectively respond to global climate change.

Not Applicable, subject to confirmation against the official Patent Center application data.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ELECTRONICALLY

Not Applicable.

### STATEMENT REGARDING PRIOR DISCLOSURES BY THE INVENTOR OR A JOINT INVENTOR

Not Applicable.

### FIELD OF THE INVENTION

The disclosure relates to computer-implemented coordination of consumer recommendations, consumer orders and payments, aggregated demand, product specification and design, manufacturer selection, on-demand production, and direct delivery through an artificial-intelligence core.

### BACKGROUND OF THE INVENTION

Conventional retail, forecasting, manufacturing, and distribution arrangements can separate consumer decision data and actual order data from production-capacity, product-specification, payment, inventory, and delivery data. The disclosed platform uses the components and operations described throughout the original disclosure to coordinate those data with production and direct delivery.

### ADDITIONAL TECHNICAL FIELD AND RELATED—ART DESCRIPTION

### (1) Field of the Invention

The present invention relates generally to the field of digital commerce, artificial intelligence-driven supply chain management, distributed cloud computing architectures, and computer-implemented economic systems. More specifically, the invention pertains to a computer-implemented method and platform system that utilizes artificial intelligence, big data analytics, distributed ledger technology, IoT sensor networks, and cloud-based computational models to optimize consumer decision-making, synchronize production with consumption, and eliminate waste in production and consumption processes through demand-driven supply, distribution, and purchasing.

### (2) Description of Related Art

In traditional manufacturing and retail models, a fundamental information asymmetry exists between consumers and manufacturers. Under the conventional business-to-consumer (B2C) marketing and production paradigm, manufacturers produce goods based on market estimates, forecasts, and projections rather than on verified, exact consumer demand. This approach inherently leads to several persistent technical problems:

First, manufacturers engage in what may be characterized as “random production”—producing goods without precise knowledge of whether, when, and in what quantities consumers will purchase them. This results in significant overproduction, excess inventory, and massive waste across all industries. For example, as reported by the Alibaba Research Institute, the Chinese clothing industry alone generates annual waste of 400 billion yuan in the production process and 400 billion to 800 billion yuan in the consumption process due to blind and random production by manufacturers and blind and random consumption by consumers.

Second, consumers engage in what may be characterized as “random consumption”—making purchasing decisions without adequate information about product quality, price optimization, or the true cost-performance ratio across global markets. This leads to inefficient allocation of consumer resources, wasted time in decision-making, and suboptimal purchasing outcomes.

Third, traditional manufacturers must bear substantial fixed costs that are ultimately passed on to consumers, including advertising expenses, sales and marketing costs, distribution expenses, and bank loan interest costs. These costs typically account for 25% to 40% of final product prices, representing a significant inefficiency in the traditional economic model.

Fourth, existing e-commerce platforms, while providing improved access to products, do not fundamentally solve the underlying problem of production-consumption misalignment. Platforms such as Amazon, Alibaba, JD.com, and Pinduoduo primarily serve as intermediaries between manufacturers and consumers but do not actively synchronize production with verified demand or eliminate the fixed cost burdens that manufacturers must bear.

Fifth, while various prior art systems have addressed aspects of demand forecasting, consumer behavior analysis, and supply chain optimization, none have provided a comprehensive, AI-driven platform that aggregates exact consumer demand, coordinates on-demand production, eliminates fixed costs through a pre-payment model, and delivers products directly from manufacturers to consumers without retail intermediaries.

The present invention addresses these technical problems through a specific, non-generic AI Core architecture deployed across a distributed network of cloud application servers, database clusters, and machine learning inference engines configured to execute specific algorithmic instructions in real-time. The AI Core utilizes tensor processing unit (TPU) clusters specifically optimized for parallel execution of supply-demand equilibrium algorithms. The system collects data by extracting telemetry vectors from user devices and parsing them through a natural language processing (NLP) and predictive analytics pipeline. To handle global scale (N->infinity), the network utilizes dynamic load balancing and auto-scaling cloud microservices to prevent network bottlenecking during high-frequency concurrent transaction periods.

Accordingly, there exists a critical and unmet technical need in the art for a computer-implemented method and platform that leverages artificial intelligence—not merely to predict or forecast demand probabilistically, but to aggregate exact, deterministic consumer demand data and execute physical production and distribution instructions based on that verified demand. Unlike prior art systems that rely on probabilistic forecasting models (such as US20230058770, which uses machine learning to estimate future sales based on historical patterns), the present invention operates on a fundamentally different technological principle: deterministic aggregation of verified purchase intent, followed by direct execution of manufacturing and logistics instructions without intermediate probabilistic estimation. This shift from probabilistic forecasting to deterministic execution represents a paradigm change in computer-implemented supply chain architecture.

### SUMMARY OF THE INVENTION

In disclosed embodiments, an AI Core (200) receives consumer information, orders, and payments; AI Aggregation (205) determines an exact requested quantity and product type; AI Specification (210) defines product requirements; AI Design (215) develops or selects a product design; AI Manufacturing (220) coordinates production with a registered manufacturer; and AI Direct Delivery (225) coordinates delivery directly from the manufacturer to consumers.

Registered manufacturers may be associated with MMPALL (305), MMPS (310), MMPSS (315), or MMPM (320), corresponding in disclosed examples to standardized goods, bulk orders, niche products, and custom products. The AI Core may match aggregate demand and product requirements to manufacturer production capacity and product specifications.

Production may be conditioned on orders and payment, limited according to aggregated demand, updated in response to later order, inventory, environmental, or logistical data, and followed by direct delivery. These computer-executed operations are the disclosed operational mechanisms; references elsewhere to saving time, lowering cost, reducing waste, helping low-income consumers, sustainability, or changing commercial behavior describe possible results or uses and do not replace the disclosed operational mechanisms.

### ADDITIONAL SUMMARY OF DISCLOSED EMBODIMENTS

The present invention provides a computer-implemented method and intelligent platform system, referred to as MMPALL+S+SS+M, that revolutionizes global commerce by enabling manufacturers to produce and deliver products directly to consumers through an AI-driven core, optimizing product quality, minimizing costs, and aggregating consumer demand to achieve the best cost-performance ratio.

In one aspect, the invention comprises a computer-implemented method for optimizing consumer decision-making and production planning, implemented via an intelligent platform system comprising a non-retail digital ecosystem that integrates artificial intelligence (AI), big data analytics, and cloud-based computational models. The method includes: collecting individual and aggregated user behavior data, financial capability data, preference signals, and environmental data from a plurality of consumers; aggregating, by an AI Core of the platform, the collected data to determine an exact demand quantity and type of products required; generating product specifications and design based on the aggregated demand; transmitting production orders and full payments from consumers to manufacturers, wherein the full payments are received before production; producing products based on the production orders, wherein the manufacturer does not incur costs for sales, marketing, inventory, advertisement, or financing; and delivering the produced products directly from the manufacturer to consumers, bypassing retail layers. Production and consumption are synchronized by the AI Core to eliminate random production and random consumption.

In one embodiment, the AI Core comprises five synergistic sub-components that perform specific technical functions: AI Aggregation, which aggregates collected data to determine exact demand quantities (N and M); AI Specification, which defines product specifications based on aggregated demand; AI Design, which generates optimized product designs; AI Manufacturing, which coordinates production orders to manufacturers; and AI Direct Delivery, which coordinates direct delivery of products to consumers. Through this specific architecture, production and consumption are synchronized to eliminate random production and random consumption, thereby solving the technical problem of systemic waste in production and consumption processes. The AI Core and platform are specifically configured to perform these functions, which cannot be performed by human mental effort alone, and produce tangible technical effects including elimination of fixed costs for manufacturers, reduction of product prices by 25-40%, and elimination of waste.

The platform further comprises a distributed network architecture incorporating: (i) a decentralized network of edge computing devices and centralized cloud processors; (ii) TPU clusters for parallel execution of equilibrium algorithms; (iii) IoT sensor feedback loops for real-time supply chain recalibration; (iv) P2P smart contract execution protocols; and (v) a tamper-evident distributed ledger for auditability. This specific combination of hardware architectures and network protocols is absent from all prior art references cited by the Examiner, including JP 2024098361 (which relies on physical retail infrastructure), US20230058770 (limited to probabilistic forecasting), CN 111461806 (AR-based marketing only), and US20080288889 (consumer targeting only).

The AI Core comprises five synergistic sub-components that perform specific technical functions: AI Aggregation, which aggregates collected data to determine exact demand quantities (N and M); AI Specification, which defines product specifications based on aggregated demand; AI Design, which generates optimized product designs; AI Manufacturing, which coordinates production orders to manufacturers; and AI Direct Delivery, which coordinates direct delivery of products to consumers. Through this specific architecture, production and consumption are synchronized to eliminate random production and random consumption, thereby solving the technical problem of systemic waste in production and consumption processes. The AI Core and platform are specifically configured to perform these functions, which cannot be performed by human mental effort alone, and produce tangible technical effects including elimination of fixed costs for manufacturers, reduction of product prices by 25-40%, and elimination of waste.

### BRIEF DESCRIPTION OF THE DRAWINGS

FIG. 1A and FIG. 1B depict consumer demand and consumption information, the AI Core and its aggregation, specification, design, manufacturing, and direct-delivery functions, registered manufacturers and production tiers, and example consumer-side outputs.

FIG. 2A and FIG. 2B depict paid consumer orders, registered and non-platform manufacturers, the AI Core, production tiers, order and payment information, direct manufacturer-to-consumer delivery, and possible cost and efficiency effects.

### ADDITIONAL DESCRIPTION OF DRAWING VIEWS

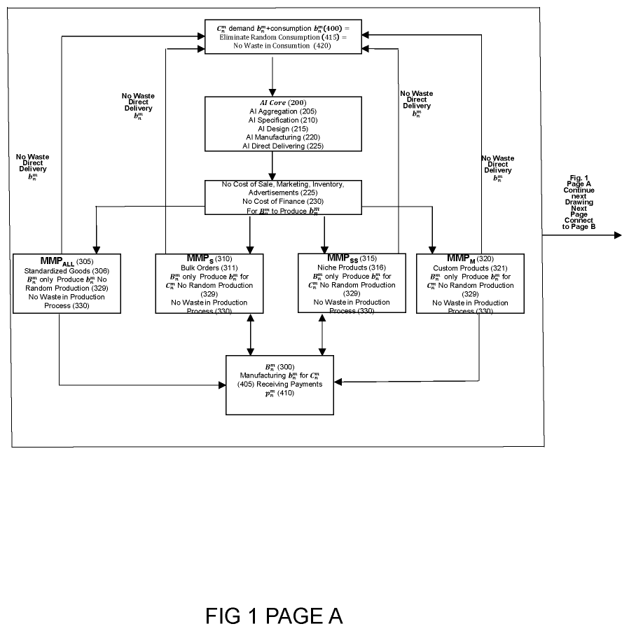

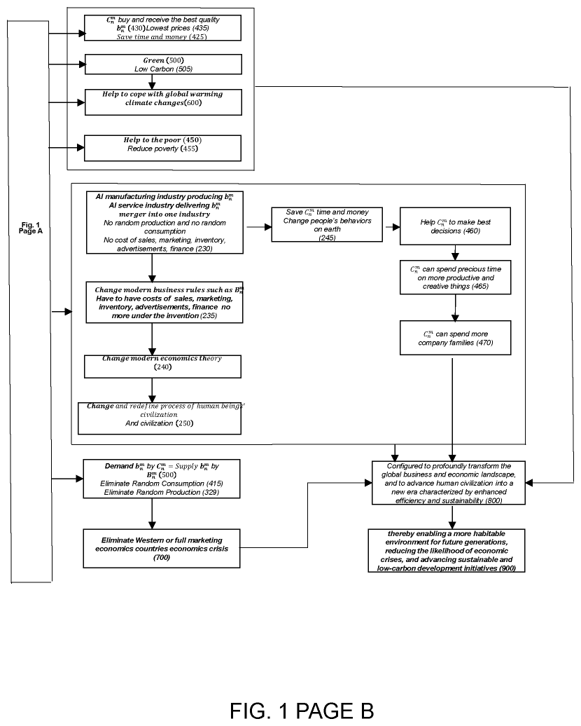

FIG. 1 is a schematic diagram illustrating the system architecture and process flow of the MMPALL+S+SS+M platform, showing the AI Core, consumer demand input, demand aggregation, AI specification, AI design, AI manufacturing, AI direct delivery, manufacturer interaction, and product delivery.

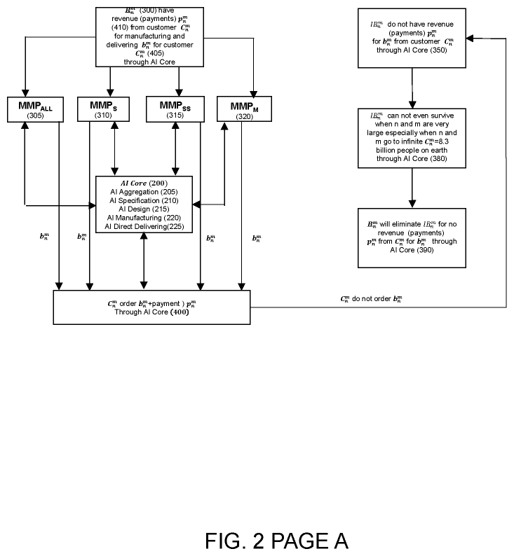

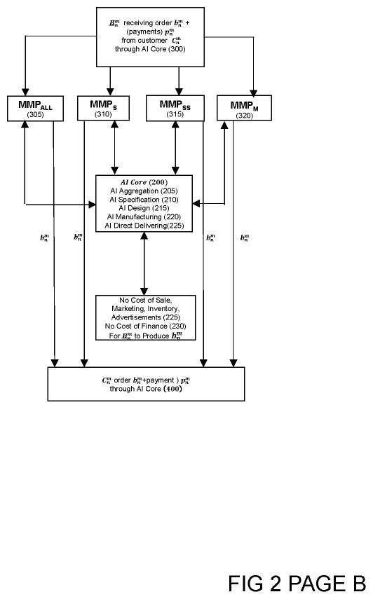

FIG. 2 PAGE A is a schematic diagram illustrating how the AI Core eliminates random production and random consumption, demonstrating that C_n\hat{ }m demand and consumption through AI Core equals B_n\hat{ }m only manufacturing b_n\hat{ }m, resulting in no waste in production process and no waste in consumption process.

FIG. 2 PAGE B is a schematic diagram illustrating how manufacturers B_n\hat{ }m that belong to MMPALL+S+SS+M through AI Core eliminate manufacturers IB_n\hat{ }m that do not belong to MMPALL+S+SS+M through AI Core, due to B_n\hat{ }m having payment (revenue) p_n\hat{ }m from C_n\hat{ }m for b_n\hat{ }m through AI Core while IB_n\hat{ }m do not.

FIG. 3 is a schematic diagram illustrating that manufacturers B_n\hat{ }m incur no cost of sales, marketing, inventory, advertisement, or finance (interest) since B_n\hat{ }m receive ordered products b_n\hat{ }m and payments p_n\hat{ }m from customers C_n\hat{ }m through AI Core.

FIG. 4 is a schematic diagram illustrating the competitive dynamics between B_n\hat{ }m (platform manufacturers) and IB_n\hat{ }m (non-platform manufacturers), showing that B_n\hat{ }m eliminate IB_n\hat{ }m due to cost advantages.

FIG. 5 is a schematic diagram illustrating how the invention saves people's time and money through AI-driven product recommendations and direct manufacturer-to-consumer delivery.

FIG. 6 is a schematic diagram illustrating how the invention enables the entire manufacturing industry to become a service industry, creates a revolutionary wave, and eliminates manufacturers that do not belong to the AI Core platform.

### DETAILED DESCRIPTION OF THE INVENTION

### Additional Detailed Description and Implementation Embodiments

The present invention, embodied in the MMPALL+S+SS+M platform (hereinafter referred to as “the Platform”), revolutionizes global commerce by enabling manufacturers to produce and deliver products directly to consumers through an AI-driven core, optimizing product quality, minimizing costs, and aggregating consumer demand to achieve the best cost-performance ratio. The Platform transforms traditional manufacturing and retail by facilitating direct transactions between manufacturers (B_n\hat{ }m) and consumers (C_n\hat{ }m) through an AI Core. The Platform leverages advanced technologies, including big data, cloud computing, machine learning, 5G, and photon quantum computing, to aggregate consumer demand, optimize product design and production, and deliver products with the best quality and lowest prices globally.

Specifically, the AI Core is deployed across a distributed network of cloud application servers and database clusters, utilizing dynamic load balancing and auto-scaling cloud microservices to prevent network bottlenecking during high-frequency concurrent transaction periods. Furthermore, the computational workloads, particularly those executing supply-demand equilibrium algorithms, are processed in parallel on dedicated tensor processing unit (TPU) clusters. To minimize latency in transaction routing, the system architecture incorporates decentralized edge computing devices that execute cryptographic secure multi-party computation, verifying financial capability and executing matching protocols without exposing raw user data.

The Platform operates on a consumer-to-business (C2B) model, where production is initiated only after consumers place orders and provide full payments. This contrasts with traditional business-to-consumer (B2C) models, where manufacturers produce goods based on market forecasts, often leading to overproduction and inventory costs. By aggregating exact demand quantities (N>No), the AI Core ensures that manufacturers produce only what is needed, eliminating inventory costs and waste.

### 2. SYSTEM ARCHITECTURE

### 2.1 The AI Core

The AI Core (200) is the central processing hub of the Platform, responsible for receiving consumer orders, aggregating demand, recommending products, coordinating production, and processing payments. The AI Core uses advanced technologies to analyze consumer needs, optimize product quality, and ensure minimal pricing. The AI Core comprises five synergistic sub-components:

AI Aggregation (205): The process of collecting and analyzing consumer demand data to determine the exact quantity (N>No) and type (M) of products required. This ensures precise demand forecasting, unlike traditional market estimates. The AI Aggregation component collects and analyzes consumer demand data to determine the exact quantity and type of products required.

This aggregation is achieved by extracting telemetry vectors from user devices and parsing them through a natural language processing (NLP) pipeline. The AI module includes multi-layer deep neural networks, specifically utilizing a convolutional neural network (CNN) for feature extraction of consumer preference signals, and a recurrent neural network (RNN) trained on historical multi-regional datasets to generate programmatic production volume matrices. Once demand is quantified, the platform executes a bipartite graph matching algorithm that mathematically aligns real-time inventory nodes from manufacturers with the instantaneous user demand nodes, outputting the optimized decisions as structured data packets directly to the user's graphical user interface.

AI Specification (210): The AI-driven process of defining product specifications based on consumer needs and market trends. The AI Core defines product specifications based on consumer preferences, historical data, and market trends, ensuring products meet the highest quality standards.

AI Design (215): The AI-driven design phase, where products are tailored to meet consumer preferences and quality standards. Products are designed using AI-driven insights, optimizing for quality, functionality, and cost-effectiveness.

AI Manufacturing (220): The AI-coordinated production phase, ensuring efficient, high-quality manufacturing with minimal costs. The AI Core coordinates production by assigning orders to manufacturers under MMPALL, MMPS, MMPSS, or MMPM, ensuring efficient, high-quality output.

This coordination is executed by translating the AI-generated predictive consumption models into automated manufacturing control signals, which are transmitted directly via secure machine-to-machine (M2M) protocols to factory-floor programmable logic controllers (PLCs). The manufacturing process is continuously governed by an integrated Internet of Things (IoT) sensor feedback loop that dynamically recalibrates supply chain routing tables in milliseconds. Furthermore, the platform ingests real-time IoT emissions data from these manufacturing facilities and applies a carbon-weighting penalty function to the AI demand-matching algorithms, ensuring that production requests are terminated or redirected if a manufacturer's inventory or carbon output exceeds computationally defined thresholds.

AI Direct Delivery (225): The AI-coordinated delivery of products directly from manufacturers to consumers, bypassing retail layers.

### 3.1 Demand Aggregation

The Platform aggregates consumer demand to achieve economies of scale, reducing per-unit costs and enabling the lowest prices. The AI Core collects exact demand quantities (N>No), ensuring no overproduction or waste. This contrasts with traditional models, such as China's National Healthcare Security Administration's drug procurement, which relies on estimated quantities. The Platform's exact demand aggregation:

### 3.2 AI-Driven Quality Optimization

The Platform uses AI to achieve the best product quality. The AI Core employs advanced technologies:

This AI-driven approach fundamentally differs from prior art systems that merely analyze consumer behavior data for marketing purposes (e.g., IN 202221030956, which is a theoretical study of psychological factors affecting purchase decisions, and US20080288889, which targets one-on-one marketing). Unlike these references, the present invention's AI Core does not generate marketing recommendations or targeted advertisements. Instead, it executes a deterministic data routing protocol that aggregates verified demand signals and directly triggers physical manufacturing and distribution operations, bypassing and eliminating all intermediate marketing and advertising data processing layers. This represents a structural difference in the computational architecture: the present invention affirmatively removes marketing data parameters from the manufacturing decision loop, whereas the cited prior art systems are designed to enhance and optimize those very marketing parameters.

### 3.3 Best Cost-Performance Ratio

The Platform delivers products with the best cost-performance ratio. This is achieved through:

Lowest Prices: Demand aggregation and cost elimination enable prices 25%-40% below market rates.

Cost Savings: Products priced 25%-40% below market rates due to cost-free production and demand aggregation.

### 5. SECURITY AND AUTHENTICATION

The Platform employs cryptographic protocols to ensure secure transactions:

Transactions and automated decisions are executed by deploying peer-to-peer (P2P) smart contract execution protocols over the decentralized network. Automated intelligent software agents transform natural language behavioral signals into machine-executable application programming interface (API) calls processed securely over an encrypted transport layer. To ensure transparency and auditable post-transaction performance validation, all algorithmic decision pathways and executed smart contracts are recorded in a tamper-evident distributed ledger. Additionally, social impact functions, such as poverty reduction, are executed by automatically generating cryptographic token transfers representing digital vouchers to verified digital wallets of eligible users.

Demand Aggregation: The Platform uses exact demand quantities (N>No), unlike prior art's model.

The present invention is further distinguished from the specific references cited by the Examiner as follows:

Regarding JP 2024098361 (Matsumoto): This reference fundamentally relies on physical brick-and-mortar store infrastructure (“dedicated stores”) and traditional financial mechanisms (“regular borrowing”). Conversely, Applicant's amended claims specifically recite a distributed digital architecture that initiates “direct automated delivery logistics without intermediate retail inventory caching,” and systematically filters for manufacturing nodes with “zero-value” marketing and financial costs. This explicitly teaches away from the physical, high-overhead retail networks proposed by Matsumoto.

Regarding US20230058770 (Sack): Sack discloses the utilization of machine learning models exclusively for probabilistic “demand forecasting” (i.e., estimating future sales based on historical patterns). Applicant's invention architecture strictly relies on the deterministic aggregation of “verified purchase intents without probabilistic forecasting” to trigger immediate, on-demand physical execution. The computational logic—probabilistic guessing versus deterministic parameter executing—constitutes a fundamental shift in computer science architecture that is neither taught nor suggested by Sack.

Regarding CN 111461806 (Su Bo): Su Bo focuses exclusively on Augmented Reality (AR) visual hardware linkage devices to augment and enhance marketing content. Applicant's system seeks to computationally eliminate marketing data parameters entirely from the manufacturing routing logic, requiring zero AR visualization modules. The two systems operate on opposite technological principles: Su Bo adds marketing visualization layers; the present invention removes marketing layers entirely.

Regarding US20080288889 (Hunt): Hunt is directed toward maximizing the efficacy of targeted advertising (“one-on-one marketing”). In stark contrast, Applicant's system architecture executes a rigid parameter verification ensuring that selected manufacturing nodes possess a “zero-value parameter” for advertising databases. It structurally deletes the very marketing algorithms that Hunt seeks to optimize.

Regarding IN 202221030956 (Dr. Jitendra Patel): This reference is a purely theoretical academic paper discussing psychological, sociological, and cultural factors affecting consumer purchase decisions. It discloses no computer-implemented technical solution, no system architecture, no algorithms, and no hardware implementation.

Regarding Wang et al. (2023)—“Exploring Sustainable Development Pathways for Agri-Food Supply Chains Empowered by Cross-Border E-Commerce Platforms”: This is a theoretical academic paper analyzing policy pathways and sustainability factors. It does not disclose any computer-implemented method, system architecture, or technical solution. It is descriptive rather than operative.

The Examiner's own citations demonstrate that AI applied to supply chain and commerce optimization is patent-eligible subject matter. The Examiner cited US20230058770 (Sack), which discloses a demand forecasting engine using machine learning—a system that has been deemed patent-eligible by the USPTO. If a probabilistic forecasting system is patent-eligible, then Applicant's deterministic aggregation and execution system—which solves a different technical problem (eliminating random production and consumption waste) using fundamentally different technical means (deterministic data routing, zero-fixed-cost parameter validation, and direct PLC control)—is likewise patent-eligible. Similarly, the Examiner cited CN 111461806 (Su Bo), which discloses an AR-based marketing platform that has been granted patent protection. If an AR marketing platform is patent-eligible, then Applicant's system—which eliminates marketing entirely through zero-fixed-cost parameter validation—is even more clearly patent-eligible as it provides a greater technological improvement over the prior art. The cited references thus support, rather than undermine, Applicant's position that the claimed invention is patent-eligible under 35 U.S.C. Section 101. The patent-eligibility of these cited references demonstrates that the technological field of AI-driven supply chain and commerce optimization is not categorically excluded from patent protection, and the present invention's unique combination of features—deterministic demand aggregation, zero-fixed-cost validation, distributed TPU architecture, IoT feedback loops, and P2P smart contract execution—represents a further technological advancement over these already-patented systems.

The Platform is designed to scale globally, supporting up to 8.3 billion consumers. As N and M increase, the AI Core's ability to aggregate demand and optimize production ensures continued efficiency. Key scalability features include:

### 8. IMPLEMENTATION EXAMPLES

### 8.1 Electronics (MMPALL)

### 8.2 Appliances (MMPS)

### 8.3 Handcrafted Items (MMPSS)

### 8.4 Personalized Products (MMPM)

### 9. INDUSTRIAL APPLICABILITY

The method and platform have broad industrial applicability across all industries, including but not limited to:
Manufacturing: All types of manufacturing, from heavy industries (automotive, machinery) to light industries (electronics, clothing, food)
Real Estate: Crowdfunding and direct construction of housing
Healthcare: Medical supplies, pharmaceuticals, and healthcare services
Education: Educational products and services
Retail: All consumer goods and services
Financial Services: Banking, wealth management, and financial technology
Logistics: Supply chain management and distribution

The AI Core architecture described herein has broad industrial applicability across all sectors. The AI Aggregation component is applicable to any industry requiring demand forecasting and supply chain optimization. The AI Specification and AI Design components are applicable to any industry requiring product design and development. The AI Manufacturing component is applicable to any industry involved in manufacturing, including heavy industries (automotive, machinery, aerospace), light industries (electronics, clothing, food), and services (healthcare, education, financial services). The AI Direct Delivery component is applicable to any industry requiring product distribution and logistics. The elimination of fixed costs through pre-payment, demand aggregation, and direct delivery is applicable to all industries where manufacturers bear significant fixed costs. The specific technical solution provided by the AI Core—synchronizing production with consumption to eliminate waste—is applicable to any industry where misalignment between production and consumption causes inefficiency and waste. The platform's scalability, as demonstrated by the formula C_n\hat{ }m in B B_n\hat{ }m b_n\hat{ }m+SUM(AI_i+I_i+P_i+ . . . ) with n->infinity and m->infinity, ensures applicability across diverse industries and global markets.

### 10. BEST MODE OF CARRYING OUT THE INVENTION

The best mode of carrying out the invention is exemplified by the real estate industry application, which demonstrates that the method and platform are feasible, workable, and can be implemented and realized.

In the real estate example, the method operates as a form of “non-retail” planned economy under market economics that supplies according to demand and meets the needs of consumers. Under this method and platform, companies and manufacturers do not have to pay advertising, sales, or marketing costs, nor do they have to pay interest on bank loans. Consumers do not have to keep their money in the bank for a low interest rate, but can use it for collective funding and purchase products at a 25% to 40% lower price than the market price.

Companies under this method, platform, and patent do not need to borrow from banks and pay interest costs. The funds raised by consumers or members under this method, platform, and patent are sufficient to cover all the costs or funds required to build commercial housing.

### 11. SUCCESSFUL EXAMPLES THAT VALIDATE THE INVENTION

Example 1—Roosevelt's New Deal (1933-1945): The Roosevelt New Deal, implemented during the later stages of the Great Depression in the United States, was to some extent planned economics under market economics. Under this plan, banks were assisted and allocated, and factories and enterprises were directed to produce specific products and goods, successfully leading the United States out of the Great Depression and restoring its economy.

Example 2-Reconstruction Finance Corporation (RFC) and Defense Plant Corporation (DPC) during World War II: The RFC, established in 1929 to revive the economy after the stock market crash, established the Defense Plant Corporation (DPC), which accounted for 25% of US GDP near the end of WWII. The DPC provided loans and tax incentives for tank, aircraft, and other weapons manufacturing. With the help of this defense plant company, US manufacturing capacity increased by 50% by the end of World War II.

Example 3—Centralized Procurement by Chinese National Medical Insurance Administration: The centralized procurement of drugs and medical consumables by the Chinese National Medical Insurance Administration resulted in an average price drop of more than 90% from an average price of 13,000 yuan to 700 yuan per unit.

Example 4—Pre-paid Orders in Commercial Aviation: Prior to the end of 2019 during the COVID-19 pandemic, global airlines or aircraft leasing companies needed to pay cash, even full cash, to Boeing or Airbus to order planes that would only be delivered three to five years later.

The complete original specification follows verbatim. The new material preceding it organizes, but does not replace or disclaim, any original embodiment.

A revolutionary, disruptive, redefining, and changing modern business rules, modern macroeconomics, modern microeconomics, process of human being civilization and human being civilization's way or the method and the method or model or the platform created to implement this method

Dr. Hu Chuanping's economic theory and practice which may and should receive the Nobel Prize in Economics or Physics.

Specifications Regarding Advantageous Effects, Description of Drawings, Best Mode, Mode for Invention, Industrial Applicability:

### Advantageous Effects: One

1. This method (model), this platform, this patent, this platform, and this patent are planned economy and supply according to demand under a market economy.
2. Supply all products, goods, and services needed by all people in the world from birth to death.
3. With the best product, goods, and service quality and the lowest prices among similar products.
4. Supply and distribute according to demand through “non-retail” in a non-traditional sense.
5. Through artificial intelligence (based on big data, cloud computing, 5G, the Internet, the Internet of Things, etc.).
6. In a “non-retail” way that is different from the traditional concept of wholesale.
7. That is, the products go directly from production through this method, model, and platform to the hands of consumers.
8. This method can be described or expressed in digital form as follows: For

$${C}_{n}^{m} ∈ {BB}_{n}^{m} {b}_{n}^{m} + \sum ( {AI}_{i} + {I}_{i} + {P}_{i} + … ) ( with i from 1 to ∞ )$$

The formular represents the formular of global consumers and manufacturers of the platform, with n→∞ and m→∞ (n and m go to infinite),

$${C}_{n}^{m}$$

represents global consumers

$${B}_{n}^{m} represents manufacturers {b}_{n}^{m}$$

represents products (produced by manufacturers

$${B}_{n}^{m}$$

or Pᵢ represents products, AIᵢ represents artificial intelligence (the industry in this field) Iᵢ represents a certain industry, Pᵢ represents a certain product N->infinity, M->infinity tends to infinity, representing that this method can cover almost all global consumers' needs from birth to death for products, goods, and services manufactured by manufacturers or producers

$${B}_{n}^{m} .$$

9. This method, this platform, and this patent claim a revolutionary and disruptive redefinition and reshaping of modern business rules, replacing them with claims including but not limited to “new retail enabling manufacturers and consumers to transact directly through this platform,” “planned economy under a market economy,” “on-demand production, supply, and distribution,” “no fixed cost expenses such as bank interest required by typical businesses,” “eliminating random or blind production by manufacturers and consumption by consumers,” “thoroughly eliminating waste in the production and consumption process,” “substituting, eliminating, and thoroughly eliminating inefficient small, medium, large, and even huge enterprises in every industry for every product, commodity, or service,” “consumers being able to buy the best quality, lowest price, and best value products, commodities, or services in the world,” “saving people's time and money in consumption,” “helping the poor and reducing poverty,” “green and low-carbon,”
   “helping to address global climate change,” and so on. Therefore, this method, this platform, and this patent change the way people work and live, as well as the way enterprises produce products in the production process.
10. This method, this platform, and this patent represent a revolutionary and disruptive redefinition, reshaping, and replacement of modern economic theory, including micro and macroeconomics, because they change, replace, disrupt, redefine, and reshape modern business rules, which constitute the core and foundation of modern economic theory to a considerable extent.
11. This method, this platform, and this patent represent a revolutionary and disruptive redefinition, reshaping, and change in the course of human civilization and human civilization itself. The revolutionary and disruptive redefinition and reshaping of modern business rules by this method, this platform, and this patent also changes the consumption behavior of people as consumers and the production behavior of enterprises in the production process. Therefore, it revolutionizes, redefines, and reshapes modern economic theory, and revolutionizes and redefines the course of human civilization and human civilization itself.

### Advantageous Effects: Two

1. This method can completely eliminate all small, medium, large, and even extra-large enterprises producing all products, commodities, and services in all industries that are inefficient, lack productivity, and outdated, such as real estate industry, commercial aircraft manufacturing, the enterprises accounted for 25% of the US GDP under the US RFC's DPC during World War II, and power plants that buy coal with cash due to coal power shortages today.
2. This method can also eliminate random or blind production by factories and random or blind consumption by consumers.
3. This method can eradicate the massive and appalling waste generated in various industries during production and consumption due to blind production and consumption. For example, a research report on China's service industry by Alibaba Research Institute pointed out that the clothing industry in China generates waste of 400 billion yuan in the production process and 400 billion to 800 billion yuan in the consumption process each year due to blind and random production by manufacturers and blind and random consumption by consumers.
4. This method will establish a wave that includes Industry 4.0 or 5.0, namely industrial artificial intelligence.
5. This method will transform manufacturing into a service industry through the application of platform-based products using MMP_{ALL+S+SS+M} and AI artificial intelligence. Where MMP_{ALL+S+SS+M}=MMP_{ALL}+MMP_{S}+MMP_{SS}+MMP_{M}, where MMP stands for “My Model and Platform,” and My refers to Dr. Chuanping Hu.
6. Therefore, this method eliminates the traditional concept of primary, secondary, and tertiary industries, and the primary, secondary, and tertiary industries (where the primary industry refers to agriculture, forestry, animal husbandry, and fisheries (excluding agricultural, forestry, animal husbandry, and fishery services). The secondary industry refers to mining (excluding mining support activities), manufacturing (excluding metal products, machinery and equipment repair and maintenance), electricity, heat, gas, and water production and supply industries, and construction. The tertiary industry refers to the service industry, which includes all industries other than the primary and secondary industries) are integrated under this method and the MMP_{ALL+S+SS+M} platform established to achieve this method.
7. This method (1) applies to when consumers

$${C}_{n}^{m} and producers {B}_{n}^{m}$$

are from different countries or regions, such as consumers

$${C}_{n}^{m} and manufacturers {B}_{n}^{m}$$

in different countries, like

$${B}_{n}^{m}$$

in China, (2)

$${C}_{n}^{m}$$

in other countries, it creates a dual cycle of domestic and international economies, and when

$${C}_{n}^{m} {B}_{n}^{m}$$

are within the same country, like in China, it creates a large domestic cycle, and (3) it involves supply-side structural reform when using more advanced and better scientific and technological means, such as artificial intelligence, to change production or satisfy constantly changing demand.

(4) This method, and the platform MMP_{ALL+S+SS+M} created to implement it,

$${C}_{n}^{m} ∈ {BB}_{n}^{m} {b}_{n}^{m} + \sum ( {AI}_{i} + {I}_{i} + {P}_{i} + … ) ( with i from 1 to ∞ )$$

The formular represents the formular of global consumers and manufacturers of the platform, with n→∞ and m→∞ (n and m go to infinite),

$${C}_{n}^{m}$$

represents global consumers

$${B}_{n}^{m} represents manufacturers {b}_{n}^{m}$$

represents products (produced by manufacturers

$${B}_{n}^{m}$$

or Pᵢ represents products, AIᵢ represents artificial intelligence (the industry in this field) Iᵢ represents a certain industry, Pᵢ represents a certain product N->infinity, M->infinity tends to infinity, representing that this method can cover almost all global consumers' needs from birth to death for products, goods, and services manufactured by manufacturers or producers

$${B}_{n}^{m} ,$$

when N and M are very large, especially as N->infinity and M->infinity, is equivalent to the RFC company of the United States during World War II, which accounted for 25% of the US GDP at that time. The platform and the consumers

$${C}_{n}^{m} and manufacturers {B}_{n}^{m}$$

on the platform together constitute the output value equivalent to the GDP of a country or region.
8. Under this method, the enterprises and manufacturers: (1) have no advertising expenses, no sales expenses or costs, and no market expenses or costs; (2) even for some or most of the companies under the platform, there are no financial costs, that is, no loan interest costs (for companies belonging to the platform that implements this method); (3) especially for companies and manufacturers belonging to the platform; (4) because there are no above-mentioned costs that non-platforms must bear, such as advertising, marketing, sales, etc.; (5) their products, goods, and services will undoubtedly be more competitive, with better and cheaper prices; (6) because the fixed costs mentioned above must be transferred to the consumers who will pay the bill; (7) because financial support and economic activity usually account for 70% or more of the support for manufacturers.
9. Therefore, this method's revolutionary and transformative reshaping and redefining of the traditional financial industry, especially the banking sector, and the contribution of this method, this platform, and this patent to human social and economic activities, account for more than 70%.
10. The artificial intelligence and other technologies adopted by this platform, which was created to implement this method, will (1) revolutionize and redefine the vertical fields of the financial industry, banks, retail, corporate operations, investments, etc.; (2) integrate the physical world and the digital world in the financial industry under this method in the future; (3) improve efficiency, safety, and customer experience.
11. In fact, the financial institutions and banks under the platform MMP_{ALL+S+SS+M} under this method, or the financial institutions and banks closely cooperating with the platform, will achieve the ultimate efficiency, safety, and customer experience, far beyond what other financial institutions and banks in the industry can compare or compete with.
12. In fact, under this method, the financial institutions and banks generated by the platform MMP_{ALL+S+SS+M} will (1) eliminate almost all other financial institutions and banks; (2) be more thorough in their impact and change to the financial and banking industry than the so-called financial technology or fintech of Ant Group, Tencent's Wealth Management Group, and their payment tools such as Alipay or WeChat Pay, in all the businesses carried out by Ant Group, Tenpay (financial tools, functions, and attributes) in payment links, small and micro loans, Yu'ebao, etc.
13. The financial institutions and banks under the platform or closely cooperating with the platform under this method will revolutionize, reshape, and redefine the financial industry, including banks and financial institutions, in a more complete and earth-shattering way, presenting a completely different form and ecology from the traditional meaning of the financial industry, demonstrating different forms and ecologies of business civilization
14. Under this method, the impact and influence of financial technologies such as artificial intelligence that collaborate closely with or operate on the platform MMP_{ALL+S+SS+M}, which is implemented in this method, will be enormous, revolutionary, and disruptive to the banking industry. This method initially applies to payments and retail, or what is soon called “non-retail,” such as corporate loans, management without loans, and wealth management. In fact, people, consumers, or members under this method and this platform, and this patent, are more willing to use their disposable income on daily necessities such as clothing, food, housing, transportation, medical care, education, elderly care, childcare, etc., with the best global quality, lowest prices, and best value, and for investment, including housing, on this platform. As a result, manufacturers and companies under this method, platform, and patent usually do not need to borrow from banks for production, advertising, sales, marketing, and distribution because the full payment for the goods received in advance through the MMP is enough to cover these expenditures. It is conceivable that people will no longer deposit money in banks, and manufacturers and companies will no longer borrow from banks. Therefore, the lifeline and pillar business of banks and the financial industry to earn interest spreads on deposits and loans will be significantly negatively impacted, making it difficult for them to survive. Banks and financial companies under this method, platform, and patent will find it difficult to survive and may even be eliminated by banks and financial companies operating on the MMP platform.
15. This method will help and serve almost all consumers from birth to near-death around the world on the platform MMP_{ALL+S+SS+M}, which is established to implement this method.
(1) Save money.
(2) Optimize the way they spend their money.
(3) Shop or receive products from the platform after it collects information, including demand information, through artificial intelligence, and pushes the products.
(4) Buy the products with the best quality and the cheapest price (compared to similar products worldwide).
(5) Therefore, the consumers on this platform can spend their money most efficiently.
(6) In some cases, the money spent on this platform is also the best investment, with the best investment return.
(7) For example, consumers on the platform can participate in collective fundraising to buy houses at a price that is 25%-40% cheaper than the market price under the platform's organization.
(8) This is because the platform's organization does not have traditional real estate companies' interest costs incurred by borrowing from banks. Additionally, there are no costs associated with sales, marketing, or advertising for vacant properties.
(9) Therefore, compared to traditional real estate companies, people on the MMP_{ALL+S+SS+M} platform can save at least 25%-40% of the above-mentioned fixed costs when purchasing houses.
(10) In other words, people on this platform can buy houses of the same quality and value at a price that is lower than the market price or 25%-40% cheaper.
(11) Thus, consumers on the MMP_{ALL+S+SS+M} platform established by this method can immediately obtain a 25%-40% return on investment while making purchases.
(12) Buying a house is both for living and investing, and it has both usage and investment attributes.
16. This method saves people a lot of time, especially for people on the platform MMP_{ALL+S+SS+M}, Or members of the platform, for what to buy, what is cost-effective, cheap, and of good quality. Furthermore, based on the available consumer spending of each consumer, this method and the platform MMP_{ALL+S+SS+M}, have made the best decisions for consumers based on artificial intelligence, including but not limited to algorithms, which determine what kind of consumers need to buy what kind of products at what stage. Additionally, the platform offers the cheapest and highest quality products in the same category globally, which are produced on demand and distributed to platform members. Especially since the platform has its own manufacturers, it can produce, supply, and distribute (after payment) products to members and consumers without the cost of advertising, sales, marketing, circulation, bank loan interest, etc.
17. This method helps poor people and reduces the poverty rate, as artificial intelligence and other platforms under MMP_{ALL+S+SS+M} can be used under the current conditions of poor people or under their disposable income. Even government subsidies or safety nets, such as Medicare and Medicaid for poor and elderly people in Western countries like the United States, and China's low-income support for poor people, can be used. Furthermore, this method and platform implementation can help poor people or those who have lifted themselves out of poverty, such as the new rural cooperative medical insurance for rural populations, and urban medical care for urban populations.

“Because this method and the implementation platform MMP_{ALL+S+SS+M} can transform the limited income of poor people, including the low-income guarantee, into the satisfaction of the needs that are most needed by the poor under optimization. In other words, this method and this platform can use artificial intelligence to transform the limited income of poor people into products and commodities that best meet their needs through their own enterprise and business.”
18. This method maximizes the elimination of waste in various industries from production to circulation to consumption. For example, in the clothing industry alone, after the complete adoption and implementation of this method and platform in China, 800 billion yuan of waste can be eliminated in the production process and 400 billion yuan in the circulation and consumption process, totaling 1.2 trillion yuan of consumption waste. This does not include other industries, including but not limited to the financial, banking, and medical industries. Therefore, this method and platform are environmentally friendly and low-carbon.
19. Thus, this method and the MMP_{ALL+S+SS+M} platform can effectively respond to global climate change.
20. All global consumers or members

$${C}_{n}^{m}$$

under this method and the MMP_{ALL+S+SS+M} platform.

$${C}_{n}^{m} ∈ {BB}_{n}^{m} {b}_{n}^{m} + \sum ( {AI}_{i} + {I}_{i} + {P}_{i} + … ) ( with i from 1 to ∞ )$$

The formular represents the formular of global consumers and manufacturers of the platform, with n→∞ and m→∞ (n and m go to infinite),

$${C}_{n}^{m}$$

represents global consumers

$${B}_{n}^{m} represents manufacturers {b}_{n}^{m}$$

represents products (produced by manufacturers

$${B}_{n}^{m}$$

or Pᵢ represents products, AIᵢ represents artificial intelligence (the industry in this field) Iᵢ represents a certain industry, Pᵢ represents a certain product N->infinity, M->infinity tends to infinity, representing that this method can cover almost all global consumers' needs from birth to death for products, goods, and services manufactured by manufacturers or producers

$${B}_{n}^{m} .$$

With N->infinity and M->infinity, (1) “non-retail” does not refer to the traditional business concept of “wholesale.” (2) Instead, under this method and platform, manufacturers MMP_{ALL} and producers

$${B}_{n}^{m}$$

under MMP_{S}, MMP_{SS}, MMP_{M}, or those with close cooperation with the platform, engage in direct transactions with consumers

$${C}_{n}^{m}$$

through the platform to form a “non-retail” buying and selling behavior.
21. The platform adopts various methods, including but not limited to short video platforms, social software, and e-commerce platforms.
(1) MMP_{ALL+S+SS+M} is not only a traditional e-commerce platform, (2) but also a traditional manufacturing platform. (3) It collects demand and wallet information, (4) and enables consumers to buy all kinds of products and goods with the best global price-performance ratio and the lowest price under the “non-retail” model.
(5) Manufacturers, merchants, and enterprises under MMP_{ALL}, MMP_{S}, MMP_{SS} and MMP_{M} have an unbeatable advantage compared to those who are not on the platform or do not cooperate with the platform. As a result, they can ultimately eliminate and replace non-platform manufacturers and enterprises.
(6). Under this method and platform, manufacturers, merchants, and enterprises produce, supply, and distribute (with payment) according to demand. They do not have to bear the rigid costs that traditional companies, manufacturers, and merchants must bear, including but not limited to advertising, consumption, and market costs, and even loan interest. Moreover, they do not produce or consume blindly and randomly, resulting in no waste.
(7) For all products in all industries, such as the research released by Alibaba Research Institute on the Chinese clothing industry, there is a waste of 800 billion to 1.2 trillion yuan each year in the production and consumption processes, with 400 billion in the production process and 400 billion to 800 billion in the consumption process.
(8) Typically, these wasted costs are passed on to consumers to pay.
22. The method and platform for all

$${B}_{n}^{m} and {C}_{n}^{m}$$

under MMP_{ALL+S+SS+M}=MMP_{ALL}+MMP_{S}+MMP_{SS}+MMP_{M}. For

$${C}_{n}^{m} ∈ {BB}_{n}^{m} {b}_{n}^{m} + \sum ( {AI}_{i} + {I}_{i} + {P}_{i} + … ) ( with i from 1 to ∞ )$$

The formular represents the formular of global consumers and manufacturers of the platform, with n→∞ and m→∞ (n and m go to infinite),

$${C}_{n}^{m}$$

represents global consumers

$${B}_{n}^{m} represents manufacturers {b}_{n}^{m}$$

represents products (produced by manufacturers

$${B}_{n}^{m}$$

or Pᵢ represents products, AIᵢ represents artificial intelligence (the industry in this field) Iᵢ represents a certain industry, Pᵢ represents a certain product N->infinity, M->infinity tends to infinity, representing that this method can cover almost all global consumers' needs from birth to death for products, goods, and services manufactured by manufacturers or producers

$${B}_{n}^{m} ,$$

### for N->infinity IVI->infinity or N>No, N<No, M>Mo, M<Mo.

This method and platform deal with the supply and demand of all kinds of necessities, goods, products, and services for various age groups from birth to the end of life around the world, including food, clothing, shelter, transportation, and more, with the best quality and lowest price provided by manufacturers and enterprises
driven by artificial intelligence as the core, and supplied and distributed according to the best cost-effectiveness on demand.

All kinds of needs from around the world, from birth to approaching death, for various products, goods, or services related to clothing, food, shelter, and transportation, are met through this platform by providing the best quality and lowest price, i.e., the best value for money, through production, supply, and distribution.

The best quality is mainly implemented and achieved through manufacturers and businesses powered by artificial intelligence at the core of this platform, while the lowest price is mainly achieved through consumers gathered on this platform who exchange quantity for price, which is almost equivalent to wholesale, but is actually a new type of “non-retail” in the sense that they purchase a particular product or goods in bulk and negotiate with e-commerce or life platforms for lower prices, and this platform enables them to buy the products or goods with the best quality and lowest price, i.e., the best value for money.

This platform gathers consumers to purchase the same product in large quantities and buys the best quality and lowest-priced products. The products or goods are either produced by the MMP_{ALL+S+SS+M}=MMP_{ALL}+MMP_{S}+MMP_{SS}+MMP_{M} on this platform itself, according to the needs, or are orders for customization, OEM, or OEM from the MMP_{SS} or MMP_{M} gathered on this platform and implemented, realized, and completed by the production, manufacturing, and supply according to the needs by the MMP_{ALL} or MMP_{S} or MMP_{SS} or MMP_{M} on this platform.

### DESCRIPTION OF DRAWINGS

This method and the platform MMP_{ALL+S+SS+M} created for implementing this method in reality. For

$${C}_{n}^{m} ∈ {BB}_{n}^{m} {b}_{n}^{m} + \sum ( {AI}_{i} + {I}_{i} + {P}_{i} + … ) ( with i from 1 to ∞ )$$

The formular represents the formular of global consumers and manufacturers of the platform, with n→∞ and m→∞ (n and m go to infinite),

$${C}_{n}^{m}$$

represents global consumers

$${B}_{n}^{m} represents manufacturers {b}_{n}^{m}$$

represents products (produced by manufacturers

$${B}_{n}^{m}$$

or Pᵢ represents products, AIᵢ represents artificial intelligence (the industry in this field) Iᵢ represents a certain industry, Pᵢ represents a certain product N->infinity, M->infinity tends to infinity, representing that this method can cover almost all global consumers' needs from birth to death for products, goods, and services manufactured by manufacturers or producers

$${B}_{n}^{m} .$$

### N->infinity, M->infinity.

The working principle and implementation process of this patent. An illustrated diagram of the composition of the working principle and implementation process of this method or platform, which includes MMP_{ALL+S+SS+M}=MMP_{ALL}+MMP_{S}+MMP_{SS}+MMP_{M}, that is, MMP_{ALL+S+SS+M} consists of or is composed of four sub-platforms: MMP_{ALL}, MMP_{S}, MMP_{SS}, and MMP_{M}.

Please see FIG. 1 in the Chart (Drawing).

FIG. 1 represents the working principle and implementation process of this patent, the illustrated figure of the composition of the working principle and implementation process of this method or platform, which includes MMP_{ALL+S+SS+M}=MMP_{ALL}+MMP_{S}+MMP_{SS}+MMP_{M}. That is, MMP_{ALL+S+SS+M} consists of or is composed of four sub-platforms: MMP_{ALL}, MMP_{S}, MMP_{SS}, and MMP_{M}.
(1) 1. Where

$${B}_{n}^{m}$$

under MMP_{ALL}, the ARM manufactured under MMP_{ALL} is one of the two important components of this platform, which is manufactured under the main drive of artificial intelligence AI, and is the best quality product, commodity or service

$${b}_{n}^{m}$$

among similar products in a country or region globally. 2. The best quality product, commodity or service among similar products is produced on demand and supplied to its members or consumers through the e-commerce platform's another ARM. 3. The platform collects people's needs from birth to death worldwide through artificial intelligence. 4. And through artificial intelligence, it is promoted and customized as C2B, forming a large-scale volume procurement. 5. This makes the price the lowest among similar products through volume discounts.
(2) MMP_{S}=MMP smell 1. It is composed of manufacturers and enterprises that are not manufactured by the platform but have close cooperation with the platform. They are guided by artificial intelligence on this platform and act as OEMs for the platform, customized and sold through the platform to the platform's consumers or members.

The platform AI ensures that the quality of the product is the best among similar products and is purchased in large

quantities through the platform's targeted bidding. N>No is a large level of quantity in a particular country produced and supplied by manufacturers and enterprises, which is then distributed (after payment) through the platform at the lowest price among similar products.

(3) MMP_{SS}=MMPsmall small. Except for N<No, it is basically the same as MMP_{S}. The platform can still guarantee that consumers can purchase the best quality products at the lowest price among similar products in a country or region globally, even if the quantity purchased through the platform has not reached a significant level. The price is still guaranteed to be the lowest because the enterprises and manufacturers under MMP_{SS} do not have fixed costs, advertising expenses, sales and marketing costs, and even bank loan interest costs (see Chapter 1 of this method, platform, and patent, and the relevant parts of Chapter 3 of the patent claim).

(4) MMP_{M}=Micros is a cooperation partner of the platform and accepts platform AI guidance to produce, including but not limited to OEMs for the platform, customized, reverse bidding, and sold through the platform to the platform's consumers or members. The best quality product is produced jointly with the platform AI, and the price is the lowest because it does not have the fixed costs, advertising expenses, sales, marketing costs, and even bank loan interest costs that general enterprises must have.

### BEST MODE

Example 1 in the real estate industry shows that the method and platform are feasible, workable, and can be implemented and realized, as it is a form of “non-retail” planned economy under market economics that supplies according to demand and meets the needs of consumers. This example also perfectly explains the patent claim that, under this method and platform, companies and manufacturers do not have to pay advertising, sales, or marketing costs, nor do they have to pay interest on bank loans. Consumers do not have to keep their money in the bank for a low interest rate, but can use it for collective funding and purchase products at a 25% to 40% lower price than the market price.

Moreover, companies under this method, platform, and patent do not need to borrow from banks and pay interest costs. The funds raised by consumers or members under this method, platform, and patent are sufficient to cover all the costs or funds required to build commercial housing.

Therefore, it is evident that this method, platform, and patent not only benefit consumers and members, enabling them to buy the world's best quality and lowest-priced products (commercial housing) with the highest cost-effectiveness on the platform, but also benefit manufacturers and companies under the platform, allowing them to win in the competition for similar products and eventually eliminate their competitors.

It is said that “raising funds to build houses” does not require traditional expenses such as advertising, marketing, sales, and bank loan interest because all the funds have been advanced, and the houses have been pre-ordered and purchased by all the fundraisers before the land was acquired. Therefore, the cost of the houses built with this fundraising method is 30%-40% lower than that of the commercial housing in the same city.

This also confirms and proves the enormous and revolutionary, disruptive, and transformative impact that this method, platform, and patent have on the banking and financial industries.

Personal consumers will no longer deposit their money into banks, and manufacturers and companies no longer need to borrow from banks.

As a result, the most important and essential business of the banking industry, earning the interest difference between deposits and loans, will suffer a huge impact and may even cease to exist.

It can be imagined that this example fully illustrates, confirms, and proves the method, platform, and patent, even in terms of figures.

It not only has a huge revolutionary, disruptive impact and change on consumers of all skin colors, populations, and age groups worldwide but also on manufacturers and companies producing various products, goods, and services in all industries worldwide.

Similarly, it has a huge revolutionary, disruptive, alternative, and eliminative impact and change on the global banking and financial industries, which may be overturned, eliminated, and replaced by this platform, method, and patent, ultimately making them no longer exist or changing their form of existence.

Moreover, since the banking and financial industries contribute more than 70% to the modern social and economic activities, 18. this method, platform, and patent will overturn, eliminate, redefine, reshape, and replace the banking and financial industries, making them no longer exist or changing their form of existence in a different way from the modern banking and financial industries.

Therefore, if the significance or contribution of this method, platform, and patent to modern social and economic activities exceeds 70%, it should not be underestimated.

The significance of the invention of this method, platform, and patent by HU Chuanping lies in its revolutionary, disruptive, and redefining role in modern and contemporary commercial rules, the process of human civilization, including but not limited to the above-mentioned banking and financial industries.

Therefore, emphasizing the great significance of the invention and creation of this method, platform, and patent is not excessive.

Its milestone role in modern and contemporary commerce, economic activities, economic theories, and the process of human civilization will become increasingly prominent.

Successful Example of the MMP_{ALL+S+SS+M}=MMP_{ALL}+MMP_{S}+MMP_{SS}+MMP_{M}'s patent

This method, this platform, and this patent's successful examples in the past can indirectly confirm and demonstrate the feasibility of this patent and its claims.

Example 2: The Roosevelt New Deal from 1933 to 1985, which was implemented during the later stages of the Great Depression in the United States, was to some extent planned economics under market economics. Under this plan, banks were assisted and allocated, and factories and enterprises were directed to produce specific products and goods, successfully leading the United States out of the Great Depression and restoring its economy before, during, and after World War II, making it a superpower after the war. Roosevelt was therefore regarded as one of America's four greatest presidents. This example proves and validates an important claim of this patent, method, and platform, which is that planned economics under market economics works and is feasible.

Example 3: During World War II, the Reconstruction Finance Corporation (RFC), a public-private cooperative reconstruction finance company established by the White House and Congress in 1929 to revive the economy after the stock market crash, established the Defense Plant Corporation (DPC), which accounted for 25% of the US GDP near the end of WWII. The DPC provided loans and tax incentives for tank, aircraft, and other weapons manufacturing and provided products and services to allied countries. With the help of this defense plant company, US manufacturing capacity increased by 50% by the end of World War II, and by 1940, the company's output accounted for 25% of US GDP. The company reshaped the US aviation and electronics industries, making them one of the largest sectors in the US economy. This example proves, confirms, and validates an important claim of this patent, method, and platform from one perspective, which is that supply according to demand is safe, feasible, and effective.

Example 4: The centralized procurement of drugs and medical consumables, such as stents, by the Chinese National Medical Insurance Administration, resulted in an average price drop of more than 90% from an average price of 13,000 yuan to 700 yuan per unit. This example proves, confirms, and illustrates from one perspective that the method and platform of exchanging quantity for price is feasible. This example was only achieved in China through the power of the National Medical Insurance Administration, which represents public hospitals and patients in China, and was not specifically aimed at any particular patient or consumer. However, this patent, method, and platform are not only aimed at specific consumer groups but also specific consumers. This makes the impact of the quantity-for-price exchange even greater, and under this patent, method, and platform or patent application, consumers or consumer groups may not only include Chinese consumers but also consumers from other countries. Thus, the impact of the quantity-for-price exchange is even greater, and consumers can benefit from this method, platform, and patent application.

Examples of success related to this method, this platform, and this patent:

Example 5: Prior to the end of 2019 during the COVID-19 pandemic, especially when demand for commercial airlines was high, global airlines or aircraft leasing companies needed to pay cash, even full cash, to Boeing or Airbus, the global duopoly, to order planes that would only be delivered three to five years later. A similar situation exists for some scarce car models such as Ferrari or Lamborghini, where consumers must pay the full price months in advance before receiving the car.

This example illustrates that for global scarce or scarce commodities, consumers are willing and have to pay the full price in advance and wait for several months or even years to receive the physical products or commodities.

This example demonstrates that this method, this platform, and this patent can ensure that consumers can purchase the highest quality and lowest priced products or goods globally, from manufacturers or companies. Consumers are willing and fully able to pay the full amount in advance before receiving the physical products or goods. As a result, manufacturers or companies such as Boeing or Airbus can use consumers' money to produce and supply (after payment), thereby significantly saving interest costs of borrowing from banks. For some industries and goods, such as the example of “crowdfunding to build houses,” enterprises no longer need to borrow from banks. The full payment made by the crowdfunding buyers or homeowners in advance covers all costs, including land acquisition, construction, decoration, and landscaping, so there are no interest payments for bank loans, nor are there any rigid expenses for advertising, sales, marketing, vacancy, etc. Therefore, in the end, the consumers who “crowdfund to build houses” can buy houses at 25%-40% below market prices (the saved 25%-40% is actually saved from interest on bank loans, advertising expenses, sales costs, marketing expenses, etc.). Of course, “crowdfunding to build houses” must be carried out within the legal and non-violating limits.

This method and the implementation platform MMP_{ALL+S+SS+M} of this patent are different from traditional e-commerce platforms such as Amazon, Tmall, Taobao, Jingdong, or PDD, as well as modern e-commerce platforms such as Douyin, Kuaishou, and Xiaohongshu, and even WeChat's mini-program. Although Amazon dominates the US market, all US companies' e-commerce sales through their own e-commerce platforms account for more than 60% of the total e-commerce sales. WeChat's mini-program was only introduced as a response to this. In 2020, its GMV may have reached 1.7 trillion yuan.

This platform is not only a new type of e-commerce platform powered by AI but also an unprecedented manufacturing platform composed of N manufacturing companies where N->infinity, meaning N tends to infinity.

It combines MMP_{ALL}'s own manufacturing, MMP_{S}'s close cooperation with the platform for large and medium-sized companies where N>No, MMP_{SS}'s close cooperation with small and medium-sized enterprises where N<No (see the cooperation method mentioned above), and MMP_{Micros}, the mini-program on this platform (similar to WeChat's mini-program), into a single platform. This platform is unique in that it is a manufacturing platform that includes manufacturers, including the platform's own manufacturing, and is also a new type of e-commerce platform for traditional manufacturing companies.

Please see FIG. 1 in the Chart (Drawing).

FIG. 1 represents the working principle and implementation process of this patent, the illustrated figure of the composition of the working principle and implementation process of this method or platform, which includes MMP_{ALL+S+SS+M}=MMP_{ALL}+MMP_{S}+MMP_{SS}+MMP_{M}. That is, MMP_{ALL+S+SS+M} consists of or is composed of four sub-platforms: MMP_{ALL}, MMP_{S}, MMP_{SS}, and MMP_{M}.
(7) While Amazon, Ali, JD, and PDD basically do not have manufacturers or customizations, contract manufacturing, or package sales of ARM under AI guidance on this platform and patent.

Under the concept of “retail”, which was created and prevailed during the early days of modern business and human civilization when people did not have good ways or tools or channels or technologies to obtain necessary information for products, goods, and services or information for productions and consumption, there are no more “so-called” traditional sales to consumers. For example, manufacturers usually do not know how many products to make to satisfy the demands of consumers, let alone also face competition from competitors. Therefore, most of the time, they only manufacture products randomly or according to studies or investigations or projections, which inevitably leads to waste in production and
consumption, such as the clothing industry in China, which generates an annual waste of 1.2 trillion yuan, and costs of advertisement, sales, marketing, as well as the cost of interests of banking loans.

However, nowadays, with the discovery and development of 5G, industrial internet, e-commerce, digitalization of industry or industrialization of digital, AI, big data, cloud computation, DNA, MRNA or RUA, biotech, quantum computing using photons and computational biology, especially with the method, platform, and patent of MMP_{ALL+S+SS+M}, which revolutionizes, reshapes, and redefines the modern business rules and civilization, traditional “retail” sales will be eliminated.

### MODE FOR INVENTION

The Business Model of MMP_{ALL+S+SS+M} and

$${C}_{n}^{m} ∈ B {B}_{n}^{m} {b}_{n}^{m} + \sum ( {AI}_{i} + {I}_{i} + {P}_{i} + … ) ( with i from 1 to ∞ )$$

The formular represents the formular of global consumers and manufacturers of the platform, with n→∞ and m→∞ (n and m go to infinite),

$${C}_{n}^{m}$$

represents global consumers

$${B}_{n}^{m} represents manufacturers {b}_{n}^{m}$$

represents products (produced by manufacturers

$${B}_{n}^{m}$$

or Pᵢ represents products, AIᵢ represents artificial intelligence (the industry in this field) Iᵢ represents a certain industry, Pᵢ represents a certain product N->infinity, M->infinity tends to infinity, representing that this method can cover almost all global consumers' needs from birth to death for products, goods, and services manufactured by manufacturers or producers

$${B}_{n}^{m} ,$$

will revolutionist, reshape, redefine modern business rules and human being's process of civilization

### (I) MMP_{ALL} Consists of

1. N+1 acquisitions
2. M+1 bootstraps
3. O+1 joint adventures

In turn consists of the followings:
1. “Non-retail”
2. “Self-made” manufacturing
3. Manufacturing the best products and goods with the help of artificial intelligence.
4.

$${B}_{n}^{m}$$

On-demand production, supply, and distribution

$${C}_{n}^{m}$$

for customization, ordering, contract manufacturing, and consignment sales.

$${C}_{n}^{m} ∈ B {B}_{n}^{m} {b}_{n}^{m} + \sum ( {AI}_{i} + {I}_{i} + {P}_{i} + … ) ( with i from 1 to ∞ )$$

The formular represents the formular of global consumers and manufacturers of the platform, with n→∞ and m→∞ (n and m go to infinite),

$${C}_{n}^{m}$$

represents global consumers

$${B}_{n}^{m} represents manufacturers {b}_{n}^{m}$$

represents products (produced by manufacturers

$${B}_{n}^{m}$$

or Pᵢ represents products, AIᵢ represents artificial intelligence (the industry in this field) Iᵢ represents a certain industry, Pᵢ represents a certain product N->infinity, M->infinity tends to infinity, representing that this method can cover almost all global consumers' needs from birth to death for products, goods, and services manufactured by manufacturers or producers

$${B}_{n}^{m} ,$$

for N->infinity M->infinity or N>No, N<No, M>Mo, M<Mo.

MMP_{ALL} is the best brand for all kinds of products and goods from various industries around the world on this platform using this method.

### (II) the ALL Brand is Implemented in the Following Three Parts:

1. Acquisition of the best N+1 global brands.
2. The best quality and lowest price products and goods created by this platform itself (through AI and other technologies) in various industries with different technological levels, including high-tech and low-tech brands.
3. Products and goods produced through cooperation with the best global platforms.

### (III)

MMPs consists of the following:
S stands for small for N>No or large
1. “Non-retail” to reverse bidding.
2. Customization+OEM+consignment production according to demand, supply, and distribution (after payment), eliminating blind random production.
3. AI guidance provided by this platform.
4. When the quantity of products N is at least M, manufacturers, merchants, and companies on this platform are free from financial costs such as advertising, marketing, and bank loan interest, reducing the pressure of operating costs.
5. All MMPs open virtual flagship stores on the platform, and AI is used to implement reverse bidding for bulk purchases (similar to China's National Medical Security Bureau's bulk purchase from global pharmaceutical companies). The platform uses AI to operate.
6. The system pushes the products produced by manufacturers and companies.

### (IV)

MMP_{SS} consists of the following:
SS stands for small small for N<No
1.
2.
3.
4. When the quantity of products N is less than No.
5.
6. The rest of the MMP_{SS} are the same as 1.2.3.5.6 in MMPs.

### (V) MMP_{M} Stands for MMP Micros Consists of the Followings:

1. Similar to WeChat mini-programs, this method and platform help small and medium-sized enterprises sell products. The platform system and mini programs, with the assistance of AI, help various small and medium sized enterprises open flagship stores.
2. Bulk purchase, AI is used to implement reverse bidding, completed by the platform using AI.
3. Compared with Tmall, Taobao, Jingdong, or PDD, manufacturers and merchants operate their own flagship stores on this platform, which includes various small and medium sized enterprises' flagship stores in MMP micros. (1) The platform uses AI to open stores. (2) The operation, including selling products and goods through reverse bidding, is entirely implemented by the platform. (3) This greatly reduces the operating and marketing costs of various small and medium sized enterprises in MMP_{M}. (4) In addition to being able to receive orders for customization, OEM, and consignment through reverse bidding and other methods on this platform, small and medium-sized enterprises under this platform can also obtain consumers under the platform.

The method and platform for all

$${B}_{n}^{m} and {C}_{n}^{m}$$

under MMP_{ALL+S+SS+M} For

$${C}_{n}^{m} ∈ B {B}_{n}^{m} {b}_{n}^{m} + \sum ( {AI}_{i} + {I}_{i} + {P}_{i} + … ) ( with i from 1 to ∞ )$$

The formular represents the formular of global consumers and manufacturers of the platform, with n→∞ and m→∞ (n and m go to infinite),

$${C}_{n}^{m}$$

represents global consumers

$${B}_{n}^{m} represents manufacturers {b}_{n}^{m}$$

represents products (produced by manufacturers

$${B}_{n}^{m} )$$

) or Pᵢ represents products, AIᵢ represents artificial intelligence (the industry in this field) Iᵢ represents a certain industry, Pᵢ represents a certain product N->infinity, M->infinity tends to infinity, representing that this method can cover almost all global consumers' needs from birth to death for products, goods, and services manufactured by manufacturers or producers

$${B}_{n}^{m} ,$$

### for N->infinity M->infinity or N>No, N<No, M>Mo, M<Mo.

This method and platform deal with the supply and demand of all kinds of necessities, goods, products, and services for various age groups from birth to the end of life around the world, including food, clothing, shelter, transportation, and more, with the best quality and lowest price provided by manufacturers and enterprises driven by artificial intelligence as the core, and supplied and distributed according to the best cost-effectiveness on demand.

All kinds of needs from around the world, from birth to approaching death, for various products, goods, or services related to clothing, food, shelter, and transportation, are met through this platform by providing the best quality and lowest price, i.e., the best value for money, through production, supply, and distribution.

The best quality is mainly implemented and achieved through manufacturers and
businesses powered by artificial intelligence at the core of this platform, while the lowest price is mainly achieved through consumers gathered on this platform who exchange quantity for price, which is almost equivalent to wholesale, but is actually a new type of “non-retail” in the sense that they purchase a particular product or goods in bulk and negotiate with e-commerce or life platforms for lower prices, and this platform enables them to buy the products or goods with the best quality and lowest price, i.e., the best value for money.

This platform gathers consumers to purchase the same product in large quantities and buys the best quality and lowest-priced products. The products or goods are either produced by the MMP_{ALL+S+SS+M}=MMP_{ALL}+MMP_{S}+MMP_{SS}+MMP_{M} on this platform itself, according to the needs, or are orders for customization, OEM, or OEM from the MMP_{SS} or MMP_{M} gathered on this platform and implemented, realized, and completed by the production, manufacturing, and supply according to the needs by the MMP_{ALL} or MMP_{S} or MMP_{SS} or MMP_{M} on this platform.

This method and platform can be mathematically proven to revolutionize, disrupt, reshape, and redefine modern business rules, the process of human civilization, and human civilization itself.

For example, this method and platform can eliminate or at least effectively reduce the waste of RMB 800 billion to 1.2 trillion in China's clothing industry each year by producing, supplying, and distributing clothing on demand in all Chinese clothing factories and by consuming clothing according to demand by all Chinese people. This example itself mathematically proves that this method and platform, or this patent claim, is superior to existing business rules and revolutionizes, disrupts, reshapes, and redefines modern business rules, as well as modern economics, whether micro or macro, the process of human civilization and human civilization.

### INDUSTRIAL APPLICABILITY

Industrial Applicability consists of MMP_{ALL+S+SS+M}=MMP_{ALL}+MMP_{S}+MMP_{SS}+MMP_{M} in Mode for Invention, Best Mode, Description of Drawings. Advantageous Effects, Technical Solution etc.

### BRIEF DESCRIPTION OF THE DRAWINGS

FIG. 1 PAGE A and FIG. 1 PAGE B illustrate Eliminate Random Production+Eliminate Random Consumption=No Waste in Production Process and No Waste in Consumption Process since

$${C}_{n}^{m} Demand and Consumption {b}_{n}^{m}$$

### Through AI Core=Through AI Core

$${B}_{n}^{m} Only Manufacturing {b}_{n}^{m}$$

for A revolutionary, disruptive, redefining, and changing modern business rules, modern macroeconomics, modern microeconomics, process of human being civilization and human being civilization's way or the method and the method or model or the platform created to implement this method.

FIG. 2 PAGE A illustrates manufacturers

$${B}_{n}^{m}$$

that belongs to MMPALL+S+SS+M through AI Core eliminate manufacturers eliminate

$${IB}_{n}^{m}$$

that do not Belongs to MMPALL+S+SS+M through AI Core due to

$${B}_{n}^{m}$$

have payment (revenue)

$${p}_{n}^{m} from {C}_{n}^{m} for {b}_{n}^{m}$$

through AI Core while

$${IB}_{n}^{m}$$

do not.

FIG. 2 PAGE B illustrates manufacturers

$${B}_{n}^{m}$$

occurs No Cost of Sale, Marketing, Inventory, Advertisements (225) No Cost of Finance (230) For

$${B}_{n}^{m} to Produce {b}_{n}^{m} since {B}_{n}^{m} receive order {b}_{n}^{m}$$

and have payment (revenue)

$${p}_{n}^{m} from {C}_{n}^{m}$$

through AI Core

The following is added into the specification of the invention: The method and apparatus of the present invention will now be discussed with the reference to FIG. 1. to FIG. 6. Where some notations are as follows for consistency MMP_{ALL+S+SS+M}=MMP_{ALL+S+SS+M}, MMPALL=MMP_{ALL}, MMPS=MMP_{S}, MMPSS=MMP_{SS}, MMP_{M}=MMP_{M},

$$C\_N \hat{} M = {C}_{n}^{m} , B\_N \hat{} M = {B}_{n}^{m} , b\_n \hat{} m = {b}_{n}^{m} , p\_n \hat{} m = {p}_{n}^{m} .$$

### FIG. 1

### DETAILED DESCRIPTION OF THE INVENTION

The present invention, embodied in the MMPALL+S+SS+M platform (hereinafter referred to as “the Platform”), revolutionizes global commerce by enabling manufacturers to produce and deliver products directly to consumers through an AI-driven core, optimizing product quality, minimizing costs, and aggregating consumer demand to achieve the best cost-performance ratio. This detailed description focuses on FIG. 1 of the accompanying drawings, titled “Customers C_N\hat{ }M Demanding Data Aggregation.” This section complies with the requirements of the United States Patent and Trademark Office (USPTO), addressing 35 U.S.C. 112(b) and 35 U.S.C. 101, while providing a clear, specific, and operative method description. The description emphasizes the aggregation of consumer demand and the use of AI to deliver the best quality products at the lowest prices, as supported by claim 1 of the patent application, and aligns with the hand-drawn schematic provided in FIG. 1.

### 1. OVERVIEW OF THE INVENTION

The MMPALL+S+SS+M platform transforms traditional manufacturing and retail by facilitating direct transactions between manufacturers (B_N\hat{ }M) and consumers (C_N\hat{ }M) through an AI Core. The Platform leverages advanced technologies, including big data, cloud computing, machine learning, 5G, and photon quantum computing, to aggregate consumer demand, optimize product design and production, and deliver products with the best quality and lowest prices globally. By aggregating exact demand quantities (N>No), the Platform ensures economies of scale, eliminates fixed costs (sales, marketing, inventory, advertisement, finance), and avoids random production and consumption. This consumer-driven model supports a wide range of products and services, from necessities (clothing, food, shelter) to specialized needs (healthcare, education), meeting the demands of a global population from birth to death.

FIG. 1 illustrates the process of aggregating consumer demand through the AI Core, which coordinates AI-driven specification, design, manufacturing, and direct delivery to produce high-quality, low-cost products. The schematic highlights the Platform's ability to categorize products across standardized, bulk, niche, and custom segments, ensuring flexibility and scalability. This aligns with claim 1, which articulate the Platform's capacity to deliver products with the best cost-performance ratio through AI optimization and demand aggregation.

### 2. FIG. 1: SYSTEM ARCHITECTURE AND PROCESS FLOW

FIG. 1 depicts the operational framework of the MMPALL+S+SS+M platform, focusing on the aggregation of consumer demand and the AI-driven production process. The schematic includes labeled components and processes, as follows:

### 2.1 Components of the System

AI Core (200): The central processing hub of the Platform, responsible for aggregating consumer demand, specifying product requirements, designing products, coordinating manufacturing, and processing payments. The AI Core leverages advanced technologies to optimize quality and cost.
AI Aggregation (205): The process of collecting and analyzing consumer demand data to determine the exact quantity (N>No) and type (M) of products required.
AI Specification (210): The AI-driven process of defining product specifications based on consumer needs and market trends.
AI Design (215): The AI-driven design phase, where products are tailored to meet consumer preferences and quality standards.
AI Manufacturing (220): The AI-coordinated production phase, ensuring efficient, high-quality manufacturing with minimal costs.
Manufacturers B_N\hat{ }M (300): Efficient manufacturers registered on the Platform, belonging to one or more tiers:
   MMPALL (305): Standardized goods (306), such as clothing and electronics.
   MMPS (310): Bulk orders (311), such as appliances.
   MMPSS (315): Niche products (316), such as handcrafted items.
   MMPM (320): Custom products (316), such as personalized items.
Customers C_N\hat{ }M (400): Global consumers who place orders for products (b_n\hat{ }m, 405) and provide payments (p_n\hat{ }m) through the AI Core. The Platform supports a scalable consumer base, potentially encompassing 8.3 billion people.
Products b_n\hat{ }m (405): Goods or services produced by B_N\hat{ }M, characterized by the best quality and lowest prices in their categories, achieved through AI optimization and demand-driven production.
Payments p_n\hat{ }m: Financial transactions from C_N\hat{ }M to B_N\hat{ }M, processed through the AI Core. Full payments are received before production, eliminating financial costs.
Cost Elimination (325, 330): The absence of fixed costs (sales, marketing, inventory, advertisement) and financial costs (interest), enabling competitive pricing.
Direct Delivery: The AI-coordinated delivery of products directly from B_N\hat{ }M to C_N\hat{ }M, bypassing retail layers.

### 2.2 Process Flow

The process begins with consumers (C_N\hat{ }M, 400) submitting orders for products (b_n\hat{ }m, 405) and payments (p_n\hat{ }m) through the AI Core (200). The AI Core performs the following steps:
1. AI Aggregation (205): Collects and analyzes consumer demand data to determine the exact quantity (N>No) and type (M) of products required. This ensures precise demand forecasting, unlike traditional market estimates.
2. AI Specification (210): Defines product specifications based on consumer preferences, historical data, and market trends, ensuring products meet the highest quality standards.
3. AI Design (215): Designs products using AI-driven insights, optimizing for quality, functionality, and cost-effectiveness, similar to how leading manufacturers innovate in their categories.
4. AI Manufacturing (220): Coordinates production by assigning orders to B_N\hat{ }M (300) under MMPALL (305), MMPS (310), MMPSS (315), or MMPM (320), ensuring efficient, high-quality output.

Manufacturers produce products without incurring fixed costs:
Sales Costs: Eliminated through direct manufacturer-consumer interactions.
Marketing Costs: Replaced by AI-driven demand analysis.
Inventory Costs: Avoided through on-demand production.
Advertisement Costs: Obviated by AI-based product matching.
Finance (Interest) Costs: Eliminated, as full payments cover production costs.

The AI Core coordinates direct delivery of products to consumers, bypassing retail layers. This results in products with the best quality and lowest prices, achieving the best cost-performance ratio globally.

### 3. DEMAND AGGREGATION AND PRODUCT OPTIMIZATION

Claim 1 articulate the Platform's core innovations: aggregating consumer demand to achieve economies of scale, using AI to optimize product quality, and delivering products with the best cost-performance ratio. This section elaborates on these mechanisms.

### 3.1 Demand Aggregation (Claim 1)

The Platform aggregates consumer demand to achieve economies of scale, reducing per-unit costs and enabling the lowest prices. The AI Core collects exact demand quantities (N>No), ensuring no overproduction or waste. This contrasts with traditional models, such as China's National Healthcare Security Administration's drug procurement, which relies on estimated quantities. The Platform's exact demand aggregation:
Scales Globally: Supports a consumer base of up to 8.3 billion people, covering necessities (clothing, food, shelter) and services (healthcare, education).
Optimizes Costs: Large order quantities (N>No) enable bulk production, lowering costs for standardized (MMPALL), bulk (MMPS), niche (MMPSS), and custom (MMPM) products.
Ensures Precision: Exact demand data eliminates random production and consumption, aligning supply with consumer needs.

For example, if 1 million consumers order smartphones, the AI Core aggregates this demand, assigns production to a B_N\hat{ }M under MMPALL, and secures full payments upfront, enabling production at the lowest cost.

### 3.2 AI-Driven Quality Optimization (Claim 1)

The Platform uses AI to achieve the best product quality, as articulated in Claim 1. The AI Core employs advanced technologies:
Big Data: Analyzes consumer preferences and market trends to inform product design.
Machine Learning: Optimizes production processes, enhancing quality and efficiency.
Cloud Computing: Enables real-time coordination across the supply chain.
5G: Facilitates rapid data transfer for seamless order processing.
Photon Quantum Computing: Enhances computational efficiency for complex design and forecasting.

This AI-driven approach ensures products are not merely responses to market demand but are innovative, forward-looking solutions, similar to how leading manufacturers create category-defining products. For instance:
In electronics, the AI Core designs smartphones with superior features and durability, tailored to consumer needs.
In fashion, the AI Core creates clothing that balances style, comfort, and affordability, based on real-time consumer data.

This disrupts traditional sales concepts, as products are proactively designed to meet future needs, ensuring market success.

### 3.3 Best Cost-Performance Ratio (Claim 1)

The Platform delivers products with the best cost-performance ratio, as articulated in Claims 1. This is achieved through:
Lowest Prices: Demand aggregation and cost elimination (325, 330) enable prices 25%-40% below market rates.
Highest Quality: AI-driven design and manufacturing ensure superior performance and durability.
Global Accessibility: Products and services meet diverse needs, from birth to death, across all industries.

For example, in healthcare, the Platform delivers medical supplies with the highest quality at the lowest prices, ensuring accessibility for global consumers.

### 4. CONSUMER BENEFITS

The Platform delivers significant benefits to consumers (C_N\hat{ }M):
Cost Savings: Products priced 25%-40% below market rates due to cost-free production and demand aggregation.
Superior Quality: AI-optimized products meet the highest standards in their categories.
Time Efficiency: Direct delivery and AI-driven recommendations eliminate research and comparison time.
Comprehensive Coverage: Supports necessities (clothing, food, shelter) and services (healthcare, education), meeting lifecycle needs.
Global Reach: Accessible to a potential 8.3 billion consumers, ensuring equitable access.

### 5. COMPLIANCE WITH USPTO REQUIREMENTS

This description ensures compliance with USPTO requirements:

5.1 35 U.S.C. 112(b)—Indefiniteness

The description presents a clear, operative method in a structured format, with each process step articulated concisely. Trademark references (e.g., Apple) have been replaced with generic descriptions (e.g., “leading manufacturers”). The process flow is organized to delineate each step, from demand aggregation to delivery, ensuring clarity and specificity. For example:
“Consumers (C_N\hat{ }M) submit orders and payments (p_n\hat{ }m) through the AI Core (200), which aggregates demand (205), specifies products (210), designs them (215), coordinates manufacturing (220), and delivers high-quality, low-cost products directly from B_N\hat{ }M.”

### 5.2 35 U.S.C. 101—Abstract Idea

The invention integrates the abstract idea of facilitating transactions into a practical application through:
Specific Technical Solution: The AI Core leverages advanced technologies to aggregate demand, optimize quality, and eliminate costs, transforming commerce.
Technical Improvement: Demand aggregation and AI-driven production eliminate inefficiencies, reducing costs and waste.
Tangible Benefits: Consumers receive high-quality, low-cost products, and manufacturers operate efficiently, ensuring scalability and global impact.

The AI Core and platform tiers are not generic computer functions but are specifically designed to optimize global commerce.

### 6. COMPARISON WITH PRIOR ART

The MMPALL+S+SS+M platform distinguishes itself from prior art. Key differences include:
Demand Aggregation: The Platform uses exact demand quantities (N>No), unlike prior art's model.
AI Optimization: The AI Core designs and produces innovative products.
Cost Elimination: The Platform eliminates fixed and financial costs, enabling lower prices, a feature not addressed by prior art.

This results in a more efficient, scalable, and consumer-centric model.

### 7. SCALABILITY AND GLOBAL IMPACT

The Platform is designed to scale globally, supporting up to 8.3 billion consumers. As N and M increase, the AI Core's ability to aggregate demand and optimize production ensures continued efficiency. Key scalability features include:
Global Connectivity: 5G and cloud computing enable real-time coordination.
AI Adaptability: Machine learning supports diverse consumer needs.
Flexible Tiers: MMPALL, MMPS, MMPSS, and MMPM accommodate standardized, bulk, niche, and custom products.

The Platform's ability to meet global needs underscores its transformative potential.

### 8. SECURITY AND AUTHENTICATION

The Platform employs cryptographic protocols, to ensure secure transactions:
Digital Signatures: Authenticate consumers and manufacturers.
Encryption: Protect payment and order data.
Secure Database: Maintain tamper-proof transaction records.

These measures ensure trust and reliability for large-scale, pre-paid orders.

### 9. IMPLEMENTATION EXAMPLES

### 9.1 Electronics (MMPALL)

Consumers order 1 million smartphones through the AI Core.
The AI Core aggregates demand, designs a high-quality smartphone, and assigns production to a B_N\hat{ }M.
The smartphones are delivered directly at 25% below market prices, with no fixed or financial costs.

### 9.2 Appliances (MMPS)

Consumers order bulk appliances (e.g., refrigerators). The AI Core aggregates demand and coordinates production, ensuring low costs and high quality.

### 9.3 Handcrafted Items (MMPSS)

Consumers order niche, handcrafted products. The AI Core designs and assigns production to specialized B_N\hat{ }M, delivering unique items at competitive prices.

### 9.4 Personalized Products (MMPM)

Consumers order custom products (e.g., tailored clothing). The AI Core designs and coordinates production, ensuring personalization without cost overhead.

### 10. CONCLUSION

The MMPALL+S+SS+M platform revolutionizes commerce by aggregating consumer demand and leveraging AI to deliver high-quality, low-cost products. By eliminating fixed and financial costs, the Platform achieves the best cost-performance ratio, meeting global consumer needs from birth to death. The flexible tier structure and AI-driven processes ensure scalability and efficiency, while direct delivery enhances consumer convenience. This description complies with USPTO requirements, addressing indefiniteness and abstract idea concerns, and positions the invention as a transformative advancement in global commerce.

### FIG. 2.

### DETAILED DESCRIPTION OF THE INVENTION

The present invention, developed by Dr. Chuanping Hu, pertains to a method and platform utilizing advanced artificial intelligence (AI) technologies to revolutionize the production, distribution, and consumption of goods and services globally by eliminating random production and consumption, thereby eradicating waste across all industries and products. The following description corresponds to the hand-drawn diagrams provided in the first attached file, detailing the operational flow and components of the AI-driven platform through FIGS. 1 to 6, with an in-depth focus on FIG. 2 as the cornerstone of the invention. This description ensures compliance with USPTO requirements under 35 U.S.C. Section 112 (b) and overcoming the 35 U.S.C. Section 101 rejection by demonstrating a practical application that improves technological processes beyond a mere abstract idea.

### FIG. 1: Overview of the AI-Driven Platform

FIG. 1 illustrates the comprehensive structure of the invention, wherein a central AI Core (200) integrates consumers (denoted as C_n\hat{ }m) and manufacturers (denoted as B_N\hat{ }M) to facilitate a seamless flow of goods and services; specifically, consumers input their demands via an interface (400) into the AI Core (200), which processes these demands and instructs manufacturers to produce only the demanded goods (b_n0\hat{ }m0), followed by direct delivery (225) to consumers, thereby eliminating traditional retail intermediaries and associated costs such as sales, marketing, inventory, and advertisement, ensuring that production aligns precisely with consumption to minimize waste.

### FIG. 1: AI Core Components

FIG. 1 delineates the internal architecture of the AI Core (200), comprising five synergistic sub-components: AI Aggregation (205), AI Specification (210), AI Design (215), AI Manufacturing (220), and AI Direct Delivery (225); the process initiates with AI Aggregation (205) compiling global consumer demand data, followed by AI Specification (210) defining precise product requirements, AI Design (215) generating optimized product designs, AI Manufacturing (220) directing production based on these designs, and AI Direct Delivery (225) coordinating efficient distribution directly to consumers, collectively ensuring that production matches verified consumer needs without randomness or excess.

### FIG. 1: Manufacturer Interaction

FIG. 1 depicts the interaction between the AI Core (200) and manufacturers (B_N\hat{ }M, labeled 300), wherein manufacturers receive specific production instructions (b_n0\hat{ }m0, labeled 405) and payment confirmations (p_n0\hat{ }m0, labeled 410) from the AI Core (200); this interaction eliminates the need for manufacturers to incur expenses related to sales, marketing, inventory, advertisement, or financing, as production commences only upon receipt of payment, thereby preventing overproduction and reducing waste in the manufacturing process.

### FIG. 1: Consumer Demand Input

FIG. 4 focuses on the consumer interface, illustrating how consumers (C_n\hat{ }m) input their specific demands and consumption preferences (b_n0\hat{ }m0) into the AI Core (200) through an interface (400); the AI Core validates these inputs to ensure specificity and quantifiability, processes payments (p_n0\hat{ }m0, labeled 410) from consumers, and links these demands directly to manufacturer production, bypassing intermediaries to prevent random consumption patterns and align consumption with production output.

### FIG. 1: Distribution and Delivery

FIG. 1 outlines the distribution mechanism, wherein AI Direct Delivery (225) manages the transfer of manufactured goods (b_n0\hat{ }m0) from manufacturers (B_N\hat{ }M) to consumers (C_n\hat{ }m) without retail channels; this direct delivery model eliminates waste in distribution by ensuring that goods are delivered only as demanded, enhancing efficiency and supporting the invention's objective of waste elimination across the supply chain.

FIG. 1: Eliminate Random Production+Eliminate Random Consumption=No Waste in Production Process and No Waste in Consumption Process since C_n\hat{ }m Demand and Consumption b_n0\hat{ }m0 through AI Core=through AI Core B_N\hat{ }M only Manufacturing b_n0\hat{ }m0

FIG. 1 embodies the core innovation of the invention, demonstrating a method wherein consumers (C_n0\hat{ }m0) input their specific demands and consumption needs (b_n0\hat{ }m0) into the AI Core (200) via an interface (400), and the AI Core (200) processes these inputs through its sub-components—AI Aggregation (205) compiles the demand data, AI Specification (210) defines exact product requirements, AI Design (215) optimizes product designs, AI Manufacturing (220) directs production, and AI Direct Delivery (225) ensures efficient distribution—to manufacturers (B_N0\hat{ }M0, labeled 300), who receive payments (p_n0\hat{ }m0, labeled 410) from consumers through the AI Core (200) and produce only the demanded goods (b_n0\hat{ }m0, labeled 405), thereby eliminating random production and ensuring no waste in the production process (330); concurrently, consumers (C_n0\hat{ }m0) order and consume only what they need (b_n0\hat{ }m0) via the AI Core (200), with direct delivery (225) from manufacturers bypassing retail intermediaries, eliminating random consumption and ensuring no waste in the consumption process.

The AI Core (200) assigns production tasks based on demand volume: MMPALL (305) manages standardized goods (306) for general demand, MMPS (310) handles bulk orders where demand exceeds a threshold (N>N0), MMPSS (315) addresses niche products where demand is below the threshold (N<N0), and MMPM (320) oversees bulk custom orders; this segmentation ensures production is precisely tailored to consumer needs, avoiding overproduction, while manufacturers incur no costs for sales, marketing, inventory, advertisement, or financing, as all demands (b_n0\hat{ }m0) and payments (p_n0\hat{ }m0) are processed through the AI Core (200), further reducing waste in the production process (330).

Alignment with Claim 2

Claim 2: The method completely eradicates random production and consumption, which have persisted since ancient times across human civilization, by leveraging the AI Core (200) to synchronize production with consumer demand; unlike traditional economic models where supply often misaligns with demand, this invention ensures manufacturers (B_N0\hat{ }M0) produce only what consumers (C_n0\hat{ }m0) request (b_n0\hat{ }m0), eliminating randomness in both production and consumption processes.

Claim 2: Building on Claim, the method eliminates the enormous waste resulting from supply-demand imbalances across all industries and products by ensuring that production and consumption are precisely matched through the AI Core (200); for example, as reported by the Alibaba Research Institute (First Finance, January 2021), the Chinese clothing industry incurs annual waste of 800 billion to 1.2 trillion yuan, with 400 billion yuan from production and 400 billion to 800 billion yuan from distribution and consumption, and this invention addresses such waste universally by preventing overproduction and excess consumption through AI-driven synchronization.

### Technological Implementation

The AI Core (200) employs advanced technologies—including big data for aggregating demand, cloud computing for processing data, machine learning for optimizing designs and predictions, 5G for rapid communication, and photon quantum computing for complex computations—to execute this method; however, the novelty lies not in these technologies themselves but in their integrated application to eliminate waste by ensuring that manufacturers produce only what is demanded (b_n0\hat{ }m0) and consumers receive only what they need, transforming global commerce into a waste-free system.

This practical application integrates the abstract idea of facilitating transactions into a technological improvement, enhancing the efficiency and sustainability of production and consumption systems worldwide, thus satisfying 35 U.S.C. Section 101 by providing significantly more than a judicial exception.

### FIG. 2

### DETAILED DESCRIPTION OF THE INVENTION

The present invention relates to a method and platform designed to facilitate direct transactions between manufacturers and consumers, leveraging advanced artificial intelligence (AI) technologies to optimize efficiency, product quality, and cost-performance ratios. This detailed description focuses on FIG. 2 of the accompanying drawings, titled “Manufacturers B_N\hat{ }M Belongs to MMPALL+S+SS+M through AI Core Eliminate Manufacturers IB_N\hat{ }M do not belong to MMPALL+S+SS+M through AI Core. B_N\hat{ }M Will Eliminate IB_N\hat{ }M due to B_N\hat{ }M has payments (revenue) p_n\hat{ }m from Customers C_N\hat{ }M for Products b_n\hat{ }m through AI Core While IB_N\hat{ }M do not.” This section addresses the requirements set forth by the USPTO, ensuring clarity, specificity, and compliance with 35 U.S.C. 112(b) and 35 U.S.C. 101.
1. Overview of the Invention The invention proposes a novel retail and non-retail platform, herein referred to as MMPALL+S+SS+M, which integrates manufacturers (denoted as B_N\hat{ }M) and consumers (denoted as C_N\hat{ }M) through an AI-driven core (AI Core). The platform eliminates inefficiencies in traditional retail and wholesale models by enabling direct, demand-driven production, supply, and distribution of products (b_n\hat{ }m) with payments (p_n\hat{ }m) flowing from consumers to manufacturers. The AI Core optimizes transactions, product quality, and pricing by leveraging technologies such as big data, cloud computing, machine learning, 5G, and photon quantum computing. The platform ensures that only the most efficient and effective manufacturers (B_N\hat{ }M) thrive, eliminating less competitive manufacturers (IB_N\hat{ }M) that do not participate in the platform.
2. FIG. 2: System Architecture and Process Flow FIG. 2 illustrates the operational framework of the MMPALL+S+SS+M platform, emphasizing the competitive advantage of manufacturers B_N\hat{ }M over IB_N\hat{ }M due to revenue generation through consumer demand. The key components and processes are described below:

### 2.1 Components of the System

AI Core (200): The central processing unit of the platform, responsible for coordinating transactions, optimizing product quality, and determining pricing based on consumer demand. The AI Core integrates advanced technologies to analyze consumer preferences, forecast demand, and ensure the best cost-performance ratio for products.
Manufacturers B_N\hat{ }M (300): These are efficient and effective manufacturers registered on the MMPALL+S+SS+M platform. They belong to one or more platform tiers: MMPALL (305), MMPS (310), MMPSS (315), or MMPM (320). Each tier represents a specialized segment of the platform, such as large-scale production, specialized services, or modular manufacturing.
Customers C_N\hat{ }M (400): Consumers or members who place orders for products (b_n\hat{ }m) through the AI Core, providing payments (p_n\hat{ }m) directly to B_N\hat{ }M. The platform supports a global consumer base, potentially scaling to 8.3 billion people.
Products b_n\hat{ }m (405): Goods or services produced and delivered by B_N\hat{ }M to meet consumer demand. These products are characterized by the best quality and lowest price in their respective categories, achieved through AI-driven optimization.
Manufacturers IB_N\hat{ }M (350): Inefficient or ineffective manufacturers that do not participate in the MMPALL+S+SS+M platform. These entities lack access to the AI Core and consumer demand, resulting in no revenue (p_n\hat{ }m) from C_N\hat{ }M.
Elimination Process (380, 390): The competitive mechanism by which B_N\hat{ }M, supported by consumer payments, outcompetes and eliminates IB_N\hat{ }M, which cannot survive without revenue.

2.2 Process Flow The process begins with consumers (C_N\hat{ }M, 400) submitting orders for products (b_n\hat{ }m, 405) through the AI Core (200). The AI Core processes these orders, aggregating demand to determine the quantity (N) and type (M) of products required. Manufacturers B_N\hat{ }M (300), registered under MMPALL (305), MMPS (310), MMPSS (315), or MMPM (320), receive these orders and produce the requested products. Upon delivery, consumers provide payments (p_n\hat{ }m) to B_N\hat{ }M, generating revenue for these manufacturers.

In contrast, manufacturers IB_N\hat{ }M (350) do not receive orders from C_N\hat{ }M because they are not integrated with the AI Core. Consequently, IB_N\hat{ }M lack revenue (p_n\hat{ }m) and cannot sustain operations, especially as N and M scale to large values or approach infinity (e.g., when C_N\hat{ }M represents the global population of 8.3 billion). This competitive disadvantage leads to the elimination of IB_N\hat{ }M (380, 390), as B_N\hat{ }M dominate the market through efficient production and direct consumer engagement.
3. Elimination of Inefficient Manufacturers The invention fundamentally disrupts traditional business models by prioritizing efficiency and effectiveness. The MMPALL+S+SS+M platform ensures that only manufacturers capable of delivering high-quality products at the lowest prices survive. This is achieved through the following mechanisms:
3.1 Demand-Driven Production Consumers (C_N\hat{ }M) dictate production by specifying their needs through the AI Core. Unlike traditional retail, where manufacturers produce based on market estimates, the platform uses exact demand quantities (N>No) to optimize production schedules and resource allocation. This eliminates overproduction and waste, making B_N\hat{ }M more efficient than IB_N\hat{ }M, which rely on less accurate forecasting methods.
3.2 AI-Driven Optimization The AI Core (200) employs advanced technologies to enhance product quality and reduce costs. For example:
   Big Data: Analyzes consumer preferences and historical demand to predict trends.
   Machine Learning: Refines production processes by identifying inefficiencies.
   Cloud Computing: Enables real-time coordination between manufacturers and consumers.
   5G and Photon Quantum Computing: Facilitates rapid data processing and secure transactions.

These technologies ensure that B_N\hat{ }M produce products with the best cost-performance ratio, similar to how leading companies like Apple achieve superior quality in their product categories.
3.3 Economies of Scale By aggregating consumer demand (N>No), the platform enables B_N\hat{ }M to achieve economies of scale, reducing per-unit costs. This contrasts with IB_N\hat{ }M, which cannot access the same volume of demand and thus face higher production costs. As N approaches infinity, the cost advantage of B_N\hat{ }M becomes insurmountable, leading to the elimination of IB_N\hat{ }M.
4. Consumer Benefits The MMPALL+S+SS+M platform empowers consumers by allowing them to exchange volume for price. By aggregating demand, consumers secure products at the lowest possible prices while ensuring the highest quality. The platform supports a wide range of products and services, including:
   Clothing
   Food
   Shelter
   Entertainment
   Education
   Healthcare
   Elderly care
   Child care

This comprehensive coverage ensures that consumers receive essential goods and services from birth to death, all optimized for quality and cost.
5. Compliance with USPTO Requirements The following clarifications are provided:
5.1 35 U.S.C. 101—Abstract Idea The invention integrates the abstract idea of facilitating transactions into a practical application by:
   Providing a specific technical solution using the AI Core, which leverages advanced technologies (big data, machine learning, etc.) to optimize production and distribution.
   Improving the efficiency of manufacturing and retail processes by eliminating intermediaries and enabling direct consumer-manufacturer interactions.
   Delivering tangible benefits, such as the best quality products at the lowest prices, through a scalable platform.

The additional elements (AI Core, platform tiers, and demand aggregation) are not merely generic computer functions but are specifically designed to transform traditional commerce into a novel, consumer-driven model.
6. Comparison with Prior Art The invention distinguishes itself from prior art, by focusing on manufacturer-consumer transactions rather than buyer-driven purchase offers. The MMPALL+S+SS+M platform directly connects manufacturers to consumers, bypassing intermediaries and optimizing production based on exact demand. This eliminates inefficiencies inherent in traditional retail and wholesale models, a feature not addressed by prior art's system.
7. Scalability and Global Impact The platform is designed to scale globally, supporting transactions for a consumer base of up to 8.3 billion people. As N and M increase, the competitive advantage of B_N\hat{ }M grows, ensuring that only the most efficient manufacturers survive. This scalability is supported by the AI Core's ability to process vast amounts of data and coordinate transactions across industries and regions.
8. Security and Authentication To ensure secure transactions, the platform employs cryptographic protocols. Manufacturers and consumers are authenticated through digital signatures and encryption, ensuring trust and non-repudiation. The AI Core maintains a secure database of transactions, protecting against fraud and unauthorized access.
9. Implementation Example Consider a scenario where consumers demand smartphones. Through the AI Core, C_N\hat{ }M submit orders for 10 million units (N=10M). The AI Core aggregates this demand and assigns production to B_N\hat{ }M, who produce smartphones with superior quality and a cost-performance ratio unmatched by IB_N\hat{ }M. Consumers receive the smartphones at a lower price due to economies of scale, while IB_N\hat{ }M, lacking access to this demand, cannot compete and are eliminated from the market.
10. Conclusion The MMPALL+S+SS+M platform revolutionizes commerce by enabling direct, AI-driven transactions between manufacturers and consumers. By eliminating inefficient manufacturers (IB_N\hat{ }M) and optimizing production through the AI Core, the platform ensures that B_N\hat{ }M deliver the best quality products at the lowest prices. This invention addresses global consumer needs, complies with USPTO requirements, and offers a scalable, secure, and efficient solution for modern commerce.

### FIG. 3

### DETAILED DESCRIPTION OF THE INVENTION

The present invention, embodied in the MMPALL+S+SS+M platform (hereinafter referred to as “the Platform”), introduces a transformative method for facilitating direct transactions between manufacturers and consumers, leveraging an artificial intelligence (AI) core to eliminate traditional business costs and inefficiencies. This detailed description focuses on FIG. 8 of the accompanying drawings, titled “Manufacturers B_N\hat{ }M Occurs No Cost of Sales, Marketing, Inventory, Advertisement, Finance (Interests) Since B_N\hat{ }M received Ordered Products b_n\hat{ }m and Payments p_n\hat{ }m from Customers C_N\hat{ }M through AI Core.” This section addresses the requirements of the United States Patent and Trademark Office (USPTO), ensuring compliance with 35 U.S.C. 112 (b) and 35 U.S.C. 101, while providing a clear, specific, and operative method description. The description emphasizes the elimination of fixed costs for manufacturers, as supported by claim 3 of the patent application, and aligns with the hand-drawn schematic provided in

### FIG. 3.

### 1. OVERVIEW OF THE INVENTION

The MMPALL+S+SS+M platform redefines modern commerce by enabling manufacturers (denoted as B_N\hat{ }M) to produce and deliver products (b_n\hat{ }m) directly to consumers (C_N\hat{ }M) based on precise demand, facilitated through an AI Core. Unlike traditional retail and wholesale models, which incur significant fixed costs such as sales, marketing, inventory, advertisement, and financial interest expenses, the Platform eliminates these costs by securing full payments (p_n\hat{ }m) from consumers before production begins. This demand-driven, AI-optimized approach ensures that manufacturers operate with unparalleled efficiency, delivering the highest quality products at the lowest prices globally. The invention disrupts conventional business rules by integrating advanced technologies, including big data, cloud computing, machine learning, 5G, and photon quantum computing, to streamline production and distribution processes.

FIG. 3 illustrates the operational mechanism by which manufacturers B_N\hat{ }M avoid traditional costs, as they receive orders and payments directly from consumers through the AI Core. This cost elimination provides a competitive advantage, enabling B_N\hat{ }M to offer products at prices 25% to 40% lower than market rates, as exemplified in real estate crowdfunding scenarios. The Platform's structure ensures scalability, security, and global applicability, supporting a consumer base potentially encompassing 8.3 billion people.

### 2. FIG. 3: System Architecture and Process Flow

FIG. 3 depicts the core functionality of the MMPALL+S+SS+M platform, highlighting how manufacturers B_N\hat{ }M incur no costs for sales, marketing, inventory, advertisement, or finance (interest) due to the receipt of orders and payments from consumers through the AI Core. The schematic includes labeled components and processes, as follows:

### 2.1 Components of the System

AI Core (200): The central processing hub of the Platform, responsible for receiving consumer orders, aggregating demand, coordinating production, and processing payments. The AI Core utilizes advanced technologies (e.g., big data analytics, machine learning, cloud computing, 5G, and photon quantum computing) to optimize product quality, pricing, and delivery schedules.
Manufacturers B_N\hat{ }M (300): Efficient manufacturers registered on the Platform, belonging to one or more tiers: MMPALL (305), MMPS (310), MMPSS (315), or MMPM (320). These tiers represent different scales and types of manufacturing, from large-scale production (MMPALL) to micro-enterprises (MMPM).
Customers C_N\hat{ }M (400): Global consumers who place orders for products (b_n\hat{ }m) and provide payments (p_n\hat{ }m) through the AI Core. The Platform supports a scalable consumer base, ranging from small groups to the entire global population.
Products b_n\hat{ }m (405): Goods or services produced by B_N\hat{ }M in response to consumer orders. These products are optimized for the best quality and lowest price in their respective categories, achieved through AI-driven design and production processes.
Payments p_n\hat{ }m: Financial transactions from C_N\hat{ }M to B_N\hat{ }M, processed through the AI Core. Payments are received in full before production, eliminating the need for manufacturers to incur debt or maintain inventory.

### 2.2 Process Flow

The process begins with consumers (C_N\hat{ }M, 400) submitting orders for products (b_n\hat{ }m, 405) through the AI Core (200). The AI Core aggregates these orders, determining the exact quantity (N) and type (M) of products required. Manufacturers B_N\hat{ }M (300), registered under MMPALL (305), MMPS (310), MMPSS (315), or MMPM (320), receive these orders along with full payments (p_n\hat{ }m) from C_N\hat{ }M. The AI Core ensures that the orders are matched with the appropriate manufacturers based on production capacity and product specifications.

Upon receiving orders and payments, B_N\hat{ }M produce and deliver the products without incurring traditional costs:
Sales Costs: Eliminated because the Platform directly connects manufacturers to consumers, bypassing intermediaries.
Marketing Costs: Unnecessary, as the AI Core promotes products based on consumer demand data.
Inventory Costs: Avoided, as production occurs only after orders and payments are received.
Advertisement Costs: Obviated, as the Platform uses AI-driven recommendations to match products with consumers.
Finance (Interest) Costs: Eliminated, as full payments cover production costs, negating the need for bank loans.

This process ensures that B_N\hat{ }M operate with maximum efficiency, delivering products at significantly lower prices than competitors outside the Platform.

### 3. ELIMINATION OF TRADITIONAL COSTS

The invention's core innovation lies in its ability to eliminate fixed costs that burden traditional manufacturers. Claim 3 of the patent application articulates this advantage, stating that manufacturers on the Platform do not incur costs for advertising, sales, marketing, inventory, or financial interest. This section elaborates on how the Platform achieves this cost elimination, with a focus on the real estate crowdfunding example provided in the patent documents.

### 3.1 Demand-Driven Production

The Platform operates on a consumer-to-business (C2B) model, where production is initiated only after consumers place orders and provide full payments. This contrasts with traditional business-to-consumer (B2C) models, where manufacturers produce goods based on market forecasts, often leading to overproduction and inventory costs. By aggregating exact demand quantities (N>No), the AI Core ensures that B_N\hat{ }M produce only what is needed, eliminating inventory costs and waste.

### 3.2 AI-Driven Optimization

The AI Core (200) leverages advanced technologies to streamline production and distribution:
Big Data Analytics: Collects and analyzes consumer demand data to predict preferences and optimize product offerings.
Machine Learning: Refines manufacturing processes by identifying inefficiencies and enhancing quality control.
Cloud Computing: Enables real-time coordination between manufacturers and consumers, reducing delays and costs.
5G Connectivity: Facilitates rapid data transfer, ensuring seamless order processing and delivery.
Photon Quantum Computing: Enhances computational efficiency for complex demand forecasting and pricing models.

These technologies enable B_N\hat{ }M to produce high-quality products without the need for expensive marketing campaigns or sales teams, as the AI Core directly matches products to consumer needs.

### 3.3 Pre-Paid Orders

The receipt of full payments (p_n\hat{ }m) before production is a critical feature of the Platform. Consumers pay for products upon ordering, providing B_N\hat{ }M with immediate capital to cover production costs. This eliminates the need for manufacturers to secure bank loans, thereby avoiding interest expenses. The real estate crowdfunding example illustrates this mechanism:
Consumers collectively fund a housing project through the Platform, covering all costs (e.g., land acquisition, construction, decoration).
The manufacturer (B_N\hat{ }M) receives these funds upfront, eliminating the need for bank financing.
Without interest costs, advertising, sales, or marketing expenses, the manufacturer can offer houses at 25% to 40% below market prices.

This model extends to other industries, such as clothing, food, and healthcare, where pre-paid orders ensure cost-free production and competitive pricing.

### 4. CONSUMER BENEFITS

The elimination of traditional costs translates into significant benefits for consumers (C_N\hat{ }M). By leveraging economies of scale and AI optimization, the Platform delivers products with the best quality and lowest prices globally. Key consumer benefits include:
Cost Savings: Products are priced 25% to 40% lower than market rates due to the absence of fixed costs.
High Quality: AI-driven design and production ensure superior product quality, comparable to industry leaders in each category.
Time Efficiency: The AI Core recommends products based on consumer needs, eliminating the need for research or comparison shopping.
Global Access: The Platform supports a diverse range of products, from necessities (clothing, food, shelter) to services (healthcare, education), accessible to consumers worldwide.

The real estate example highlights these benefits: consumers can purchase high-quality homes at a 25% to 40% discount, achieving immediate investment returns while securing housing.

### 5. COMPLIANCE WITH USPTO REQUIREMENTS

This description ensures compliance with USPTO requirements:

5.1 35 U.S.C. 112(b)—Indefiniteness

The description presents a clear and operative method in a structured, single-sentence format for key processes, as required. The process flow is organized to delineate each step, from order placement to product delivery, ensuring clarity and specificity. For example:
“Consumers (C_N\hat{ }M) submit orders for products (b_n\hat{ }m) through the AI Core (200), which aggregates demand and assigns production to manufacturers (B_N\hat{ }M) who receive full payments (p_n\hat{ }m) before producing and delivering the products.”

### 5.2 35 U.S.C. 101—Abstract Idea

The invention integrates the abstract idea of facilitating transactions into a practical application through:
Specific Technical Solution: The AI Core employs advanced technologies to optimize production, pricing, and delivery, transforming traditional commerce into a cost-free, consumer-driven model.
Technical Improvement: The elimination of fixed costs (sales, marketing, inventory, advertisement, finance) improves manufacturing efficiency and reduces consumer prices, addressing inefficiencies in traditional retail.
Tangible Benefits: Consumers receive high-quality products at significantly lower prices, and manufacturers operate without financial burdens, ensuring scalability and global impact.

The AI Core and platform tiers (MMPALL, MMPS, MMPSS, MMPM) are not generic computer functions but are specifically designed to eliminate traditional costs and optimize direct manufacturer-consumer interactions.

### 6. COMPARISON WITH PRIOR ART

The MMPALL+S+SS+M platform distinguishes itself from prior art, the MMPALL+S+SS+M platform:
Directly connects manufacturers to consumers, bypassing intermediaries.
Eliminates fixed costs by securing full payments before production.
Uses AI to optimize production based on exact demand, rather than market estimates.

This results in a more efficient, cost-effective, and scalable model, addressing inefficiencies not covered by prior art's system.

### 7. SCALABILITY AND GLOBAL IMPACT

The Platform is designed to scale to a global consumer base, potentially serving 8.3 billion people. As the number of consumers (N) and product types (M) increase, the AI Core's ability to aggregate demand and optimize production ensures that B_N\hat{ }M maintain their cost advantage. This scalability is supported by:
Global Connectivity: 5G and cloud computing enable real-time coordination across regions.
AI Optimization: Machine learning and big data analytics adapt to diverse consumer needs.
Tiered Structure: The Platform's tiers (MMPALL, MMPS, MMPSS, MMPM) accommodate manufacturers of all sizes, from large corporations to micro-enterprises.

The real estate crowdfunding example demonstrates scalability: a single project can involve thousands of consumers, with the potential to expand to millions globally.

### 8. SECURITY AND AUTHENTICATION

To ensure secure transactions, the Platform employs cryptographic protocols. Key security features include:
Digital Signatures: Manufacturers and consumers are authenticated to prevent fraud.
Encryption: Payment and order data are encrypted to ensure privacy and non-repudiation.
Secure Database: The AI Core maintains a tamper-proof record of transactions, accessible only to authorized parties.

These measures ensure trust and reliability, critical for a platform handling large-scale, pre-paid orders.

### 9. IMPLEMENTATION EXAMPLE

Consider a clothing industry scenario:
Consumers (C_N\hat{ }M) order 1 million units of a specific apparel item (b_n\hat{ }m) through the AI Core.
The AI Core aggregates demand and assigns production to a manufacturer (B_N\hat{ }M) under MMPALL.
The manufacturer receives full payment (p_n\hat{ }m) upfront, covering all production costs.
The apparel is produced and delivered without incurring sales, marketing, inventory, advertisement, or interest costs.
Consumers receive high-quality apparel at a price 25% lower than market rates, while the manufacturer operates efficiently without financial burdens.

This model applies to other industries, such as electronics, food, and real estate, demonstrating the Platform's versatility.

### 10. CONCLUSION

The MMPALL+S+SS+M platform revolutionizes commerce by eliminating traditional fixed costs for manufacturers, enabling them to deliver high-quality products at the lowest prices. By leveraging the AI Core to process pre-paid orders and optimize production, the Platform ensures efficiency, scalability, and consumer satisfaction. The real estate crowdfunding example underscores the practical application of this invention, offering consumers significant savings and manufacturers unparalleled competitive advantages. This detailed description complies with USPTO requirements, addressing indefiniteness and abstract idea concerns, and positions the invention as a transformative advancement in modern commerce.

### FIG. 4

### DETAILED DESCRIPTION OF THE INVENTION

The present invention, embodied in the MMPALL+S+SS+M platform (hereinafter referred to as “the Platform”), revolutionizes modern commerce by facilitating direct, AI-driven transactions between manufacturers and consumers, eliminating traditional business costs, and providing unparalleled competitive advantages. This detailed description focuses on FIG. 4 of the accompanying drawings, titled “Manufacturers B_N\hat{ }M Belongs to MMPALL+S+SS+M Through AI Core Do Not Have Cost of Sales, Marketing, Inventory, Advertisement, Finance (Interests) Since B_N\hat{ }M Received Ordered Products b_n\hat{ }m and Payments p_n\hat{ }m from Customers C_N\hat{ }M Through AI Core While IB_N\hat{ }M that Do Not Belongs to MMPALL+S+SS+M Through AI Core Do Have Cost of Sales, Marketing, Inventory, Advertisement, Finance (Interests), Thereby B_N\hat{ }M Will Eliminate IB_N\hat{ }M.” This section complies with the requirements of the United States Patent and Trademark Office (USPTO), addressing 35 U.S.C. 112(b) and 35 U.S.C. 101, while providing a clear, specific, and operative method description. The description emphasizes the cost elimination and competitive elimination mechanisms, as supported by Claim 3 of the patent application, and aligns with the hand-drawn schematic provided in FIG. 4.

### 1. OVERVIEW OF THE INVENTION

The MMPALL+S+SS+M platform redefines commerce by enabling manufacturers (denoted as B_N\hat{ }M) to produce and deliver products (b_n\hat{ }m) directly to consumers (C_N\hat{ }M) through an AI Core, bypassing traditional retail and wholesale intermediaries. The Platform eliminates fixed costs—sales, marketing, inventory, advertisement, and finance (interest)—for B_N\hat{ }M by securing full payments (p_n\hat{ }m) from consumers before production. In contrast, non-platform manufacturers (IB_N\hat{ }M) incur these costs, which are passed on to consumers, resulting in higher prices and reduced competitiveness. The AI Core leverages advanced technologies, including big data, cloud computing, machine learning, 5G, and photon quantum computing, to optimize production, pricing, and delivery, ensuring the highest quality products at the lowest prices globally. This cost differential enables B_N\hat{ }M to outcompete and eliminate IB_N\hat{ }M, transforming industries by prioritizing efficiency and consumer value.

FIG. 4 illustrates the competitive dynamics between B_N\hat{ }M and IB_N\hat{ }M, highlighting how the Platform's cost-elimination strategy gives B_N\hat{ }M a decisive advantage. By receiving pre-paid orders through the AI Core, B_N\hat{ }M avoid traditional expenses, while IB_N\hat{ }M's costs inflate product prices, rendering them uncompetitive. This mechanism supports claim 3, which articulates the Platform's ability to eliminate inefficient enterprises across all industries.

### 2. FIG. 4: SYSTEM ARCHITECTURE AND PROCESS FLOW

FIG. 4 depicts the operational framework of the MMPALL+S+SS+M platform, emphasizing the cost-free operation of B_N\hat{ }M and the cost-burdened operation of IB_N\hat{ }M. The schematic includes labeled components and processes, as follows:

### 2.1 Components of the System

AI Core (200): The central processing hub of the Platform, responsible for receiving consumer orders, aggregating demand, coordinating production, and processing payments. The AI Core employs advanced technologies to optimize product quality, pricing, and delivery schedules.
Manufacturers B_N\hat{ }M (300): Efficient manufacturers registered on the Platform, belonging to one or more tiers: MMPALL (305), MMPS (310), MMPSS (315), or MMPM (320). These tiers accommodate various scales of production, from large-scale manufacturing (MMPALL) to micro-enterprises (MMPM).
Customers C_N\hat{ }M (400): Global consumers who place orders for products (b_n\hat{ }m) and provide payments (p_n\hat{ }m) through the AI Core. The Platform supports a scalable consumer base, potentially encompassing 8.3 billion people.
Products b_n\hat{ }m (405): Goods or services produced by B_N\hat{ }M in response to consumer orders. These products are optimized for superior quality and minimal cost, achieved through AI-driven design and production.
Payments p_n\hat{ }m: Financial transactions from C_N\hat{ }M to B_N\hat{ }M, processed through the AI Core. Payments are received in full before production, eliminating the need for manufacturers to incur debt or maintain inventory.
Manufacturers IB_N\hat{ }M (350): Non-platform manufacturers that do not belong to MMPALL+S+SS+M. These entities incur traditional costs (sales, marketing, inventory, advertisement, finance) and transfer these costs to consumers, resulting in higher prices.
Cost Transfer and Elimination (360, 370): The mechanism by which IB_N\hat{ }M's costs inflate product prices, making them uncompetitive, while B_N\hat{ }M's cost-free operation enables lower prices, leading to the elimination of IB_N\hat{ }M.

### 2.2 Process Flow

The process begins with consumers (C_N\hat{ }M, 400) submitting orders for products (b_n\hat{ }m, 405) through the AI Core (200). The AI Core aggregates demand, determining the exact quantity (N) and type (M) of products required. Manufacturers B_N\hat{ }M (300), registered under MMPALL (305), MMPS (310), MMPSS (315), or MMPM (320), receive these orders along with full payments (p_n\hat{ }m). The AI Core matches orders with appropriate manufacturers based on production capacity and product specifications.

B_N\hat{ }M produce and deliver products without incurring traditional costs:
Sales Costs: Eliminated, as the Platform connects manufacturers directly to consumers.
Marketing Costs: Unnecessary, as the AI Core uses demand data to promote products.
Inventory Costs: Avoided, as production occurs only after orders and payments are received.
Advertisement Costs: Obviated, as AI-driven recommendations match products to consumers.
Finance (Interest) Costs: Eliminated, as full payments cover production costs, negating the need for loans.

In contrast, IB_N\hat{ }M (350) incur these costs, which are transferred to consumers (360) through higher prices for products (b_n\hat{ }m). Consumers ordering from IB_N\hat{ }M pay significantly more due to these costs, making IB_N\hat{ }M uncompetitive. As a result, B_N\hat{ }M dominate the market, eliminating IB_N\hat{ }M (370) due to their cost-free operation and lower pricing.

### 3. COST ELIMINATION AND COMPETITIVE ADVANTAGE

Claim 3 articulates the Platform's core innovation: the elimination of fixed costs for B_N\hat{ }M, providing them with unparalleled competitive advantages. This section elaborates on how the Platform achieves this cost elimination and leverages it to eliminate IB_N\hat{ }M across industries.

### 3.1 Cost Elimination Mechanism

The Platform's consumer-to-business (C2B) model ensures that production is initiated only after consumers place orders and provide full payments. This pre-paid order system eliminates the need for:
Sales Teams: Direct manufacturer-consumer interactions via the AI Core bypass intermediaries.
Marketing Campaigns: AI-driven demand analysis and product recommendations replace traditional marketing.
Inventory Management: On-demand production eliminates the need for stockpiling goods.
Advertising: The AI Core promotes products based on consumer preferences, negating advertising expenses.
Bank Loans: Full payments from consumers cover production costs, eliminating the need for financing and interest expenses.

This cost-free operation allows B_N\hat{ }M to offer products at prices significantly lower than those of IB_N\hat{ }M, who must account for these expenses in their pricing.

### 3.2 Competitive Elimination of IB_N\hat{ }M

The cost differential between B_N\hat{ }M and IB_N\hat{ }M creates a competitive imbalance. IB_N\hat{ }M's expenses—sales, marketing, inventory, advertisement, and finance—are transferred to consumers, inflating product prices. For example:
A product priced at $100 by B_N\hat{ }M might cost $125-$140 from IB_N\hat{ }M due to their fixed costs.
Consumers, incentivized by lower prices, prefer B_N\hat{ }M, reducing IB_N\hat{ }M's market share.

As demand shifts to B_N\hat{ }M, IB_N\hat{ }M struggle to compete, especially as the Platform scales to serve large consumer bases (N>No). In extreme cases, when N approaches infinity (e.g., 8.3 billion global consumers), IB_N\hat{ }M cannot sustain operations without significant revenue, leading to their elimination from the market.

### 3.3 Real Estate Crowdfunding Example

The patent documents highlight real estate crowdfunding as a practical application of this mechanism:
Consumers (C_N\hat{ }M) collectively fund a housing project through the Platform, covering costs such as land acquisition, construction, and decoration.
The manufacturer (B_N\hat{ }M) receives these funds upfront, eliminating the need for bank loans and associated interest costs.
Without expenses for sales, marketing, inventory, or advertising, B_N\hat{ }M can offer houses at 25% to 40% below market prices.
IB_N\hat{ }M, reliant on traditional financing and marketing, cannot match these prices, as their costs inflate housing prices by 25%-40%.

This example illustrates how B_N\hat{ }M's cost-free operation enables them to dominate the market, rendering IB_N\hat{ }M uncompetitive.

### 4. CONSUMER BENEFITS

The Platform's cost-elimination strategy translates into significant benefits for consumers (C_N\hat{ }M):
Lower Prices: Products are priced 25% to 40% below market rates due to the absence of fixed costs.
Superior Quality: AI-driven optimization ensures products meet the highest quality standards in their categories.
Time Efficiency: The AI Core recommends products based on consumer needs, eliminating research and comparison shopping.
Global Accessibility: The Platform supports a wide range of products and services, from necessities (clothing, food, shelter) to specialized services (healthcare, education), accessible worldwide.

The real estate example underscores these benefits: consumers secure high-quality homes at substantial discounts, achieving immediate investment returns while meeting housing needs.

### 5. COMPLIANCE WITH USPTO REQUIREMENTS

This description ensures compliance with USPTO requirements:

5.1 35 U.S.C. 112(b)—Indefiniteness

The description presents a clear, operative method in a structured format, with each process step articulated in a single sentence where appropriate. The use of trademarks has been avoided, and references to specific brands have been replaced with generic descriptions (e.g., “industry-leading manufacturers”). The process flow is organized to delineate each step, from order placement to competitive elimination, ensuring clarity and specificity. For example:
“Consumers (C_N\hat{ }M) submit orders for products (b_n\hat{ }m) through the AI Core (200), which assigns production to manufacturers (B_N\hat{ }M) who receive full payments (p_n\hat{ }m) before producing and delivering products, while non-platform manufacturers (IB_N\hat{ }M) incur traditional costs that inflate prices, leading to their elimination.”

### 5.2 35 U.S.C. 101—Abstract Idea

The invention integrates the abstract idea of facilitating transactions into a practical application through:
Specific Technical Solution: The AI Core leverages advanced technologies to eliminate costs and optimize production, transforming commerce into a cost-free, consumer-driven model.
Technical Improvement: The elimination of fixed costs improves manufacturing efficiency and reduces consumer prices, addressing inefficiencies in traditional retail.
Tangible Benefits: Consumers receive high-quality products at lower prices, and B_N\hat{ }M gain competitive advantages, ensuring scalability and global impact.

The AI Core and platform tiers are not generic computer functions but are specifically designed to eliminate costs and enable direct manufacturer-consumer interactions.

### 6. COMPARISON WITH PRIOR ART

The MMPALL+S+SS+M platform distinguishes itself from prior art. Key differences include:
Direct Manufacturer-Consumer Transactions: The Platform bypasses intermediaries.
Cost Elimination: B_N\hat{ }M avoid fixed costs through pre-paid orders, a feature not addressed by prior art.
AI Optimization: The AI Core optimizes production based on exact demand.

This results in a more efficient, cost-effective, and scalable model, addressing inefficiencies not covered by prior art.

### 7. SCALABILITY AND GLOBAL IMPACT

The Platform is designed to scale globally, supporting transactions for up to 8.3 billion consumers. As N and M increase, the AI Core's ability to aggregate demand and optimize production ensures B_N\hat{ }M's cost advantage grows. Key scalability features include:
Global Connectivity: 5G and cloud computing enable real-time coordination across regions.
AI Adaptability: Machine learning adapts to diverse consumer needs and market conditions.
Tiered Structure: The Platform's tiers accommodate manufacturers of all sizes, ensuring inclusivity.

The real estate crowdfunding example demonstrates scalability: projects can involve thousands to millions of consumers, with potential global expansion.

### 8. SECURITY AND AUTHENTICATION

The Platform employs cryptographic protocols, to ensure secure transactions:
Digital Signatures: Authenticate manufacturers and consumers to prevent fraud.
Encryption: Protect payment and order data, ensuring privacy and non-repudiation.
Secure Database: The AI Core maintains a tamper-proof transaction record.

These measures ensure trust and reliability, critical for handling large-scale, pre-paid orders.

### 9. IMPLEMENTATION EXAMPLE

Consider an electronics industry scenario:
Consumers (C_N\hat{ }M) order 1 million smartphones (b_n\hat{ }m) through the AI Core.
The AI Core assigns production to a B_N\hat{ }M under MMPALL, who receives full payment (p_n\hat{ }m) upfront.
The smartphones are produced without sales, marketing, inventory, advertisement, or interest costs.
Consumers receive high-quality smartphones at 25% below market prices.
IB_N\hat{ }M, incurring traditional costs, charge 25%-40% more, losing market share to B_N\hat{ }M.

This model applies to other industries, demonstrating the Platform's versatility and competitive impact.

### 10. CONCLUSION

The MMPALL+S+SS+M platform revolutionizes commerce by eliminating fixed costs for B_N\hat{ }M, enabling them to deliver high-quality products at the lowest prices. By leveraging the AI Core to process pre-paid orders and optimize production, the Platform outcompetes IB_N\hat{ }M, who are burdened by traditional expenses. The real estate crowdfunding example illustrates this advantage, offering consumers significant savings and B_N\hat{ }M decisive market dominance. This description complies with USPTO requirements, addressing indefiniteness and abstract idea concerns, and positions the invention as a transformative advancement in modern commerce.

### FIG. 5

### DETAILED DESCRIPTION OF THE INVENTION

The present invention, embodied in the MMPALL+S+SS+M platform (hereinafter referred to as “the Platform”), introduces a groundbreaking method for facilitating direct, AI-driven transactions between manufacturers and consumers, saving both time and money for consumers while delivering the highest quality products at the lowest prices. This detailed description focuses on FIG. 5 of the accompanying drawings, titled “The Invention Save People's Time and Money.” This section complies with the requirements of the United States Patent and Trademark Office (USPTO), addressing 35 U.S.C. 112(b) and 35 U.S.C. 101, while providing a clear, specific, and operative method description. The description emphasizes the time and cost savings for consumers, as supported by claim 3 of the patent application, and aligns with the hand-drawn schematic provided in FIG. 5.

### 1. OVERVIEW OF THE INVENTION

The MMPALL+S+SS+M platform transforms commerce by enabling manufacturers (denoted as B_N\hat{ }M) to produce and deliver products (b_n\hat{ }m) directly to consumers (C_N\hat{ }M) through an AI Core, bypassing traditional retail layers and associated costs. The Platform leverages advanced technologies, including big data, cloud computing, machine learning, 5G, and photon quantum computing, to recommend and produce products tailored to consumer needs, ensuring the best quality and lowest prices. By eliminating fixed costs (sales, marketing, inventory, advertisement, and finance) and using AI-driven recommendations, the Platform saves consumers significant time and money. Consumers benefit from discounted prices (25%-40% below market rates) and eliminate the need to research or compare products, as the AI Core proactively delivers optimal solutions.

FIG. 5 illustrates how the Platform saves time and money for consumers (C_N\hat{ }M) by delivering AI-recommended, high-quality, low-cost products directly from manufacturers. The schematic highlights the consumer experience, emphasizing the efficiency of AI-driven product recommendations and the cost savings achieved through the Platform's cost-free manufacturing model. This aligns with claim 3, which articulate the Platform's ability to save money through cost elimination and time through intelligent product recommendations.

### 2. FIG. 5: SYSTEM ARCHITECTURE AND PROCESS FLOW

FIG. 5 depicts the operational framework of the MMPALL+S+SS+M platform, focusing on the consumer experience and the mechanisms that save time and money. The schematic includes labeled components and processes, as follows:

### 2.1 Components of the System

AI Core (200): The central processing hub of the Platform, responsible for receiving consumer orders, aggregating demand, recommending products, coordinating production, and processing payments. The AI Core uses advanced technologies to analyze consumer needs, optimize product quality, and ensure minimal pricing.
Manufacturers B_N\hat{ }M (300): Efficient manufacturers registered on the Platform, belonging to one or more tiers: MMPALL (305), MMPS (310), MMPSS (315), or MMPM (320). These tiers accommodate various scales of production, from large-scale manufacturing (MMPALL) to micro-enterprises (MMPM).
Customers C_N\hat{ }M (400): Global consumers who place orders for products (b_n\hat{ }m) and provide payments (p_n\hat{ }m) through the AI Core. The Platform supports a scalable consumer base, potentially encompassing 8.3 billion people.
Products b_n\hat{ }m (330): Goods or services produced by B_N\hat{ }M in response to consumer orders. These products are characterized by the best quality and lowest prices in their categories, achieved through AI-driven optimization and cost-free production.
Payments p_n\hat{ }m: Financial transactions from C_N\hat{ }M to B_N\hat{ }M, processed through the AI Core. Payments are received in full before production, eliminating the need for manufacturers to incur debt or maintain inventory.
Time and Money Savings (420, 425): The consumer benefits of receiving AI-recommended products without needing to research or compare options, coupled with significant cost savings due to the Platform's cost-free manufacturing model.

### 2.2 Process Flow

The process begins with consumers (C_N\hat{ }M, 400) interacting with the AI Core (200), which uses machine learning and big data analytics to recommend products (b_n\hat{ }m, 330) tailored to their specific needs. These recommendations are based on consumer preferences, historical data, and real-time market analysis, ensuring the best quality and lowest prices. Consumers place orders for these products and provide full payments (p_n\hat{ }m) through the AI Core.

The AI Core aggregates demand, determining the exact quantity (N) and type (M) of products required, and assigns production to manufacturers (B_N\hat{ }M, 300) registered under MMPALL (305), MMPS (310), MMPSS (315), or MMPM (320). Manufacturers produce and deliver the products directly to consumers, bypassing retail layers. This direct delivery, combined with the absence of fixed costs (sales, marketing, inventory, advertisement, finance), enables B_N\hat{ }M to offer products at prices 25%-40% below market rates.

Consumers save time (420) because the AI Core eliminates the need to research, compare, or select products manually. They save money (425) due to the discounted prices resulting from the Platform's cost-free production model. The entire process is seamless, efficient, and consumer-centric, delivering unparalleled value.

### 3. TIME AND MONEY SAVINGS MECHANISMS

Claim 3 articulate the Platform's core innovation: saving consumers time and money through AI-driven recommendations and cost-free manufacturing. This section elaborates on these mechanisms, with specific examples from real estate and consumer goods.

### 3.1 Money Savings Through Cost Elimination

The Platform eliminates fixed costs for manufacturers (B_N\hat{ }M), enabling them to offer products at significantly lower prices. These costs include:
Sales Costs: Direct manufacturer-consumer interactions via the AI Core eliminate intermediaries.
Marketing Costs: AI-driven product recommendations replace traditional marketing campaigns.
Inventory Costs: On-demand production avoids the need for stockpiling goods.
Advertisement Costs: The AI Core promotes products based on consumer needs, negating advertising expenses.
Finance (Interest) Costs: Full payments from consumers cover production costs, eliminating the need for bank loans.

This cost-free model results in product prices 25%-40% below market rates. The real estate crowdfunding example illustrates this:
Consumers (C_N\hat{ }M) collectively fund a housing project through the Platform, covering costs such as land, construction, and decoration.
The manufacturer (B_N\hat{ }M) receives these funds upfront, eliminating the need for bank loans and interest costs.
Without expenses for sales, marketing, inventory, or advertising, B_N\hat{ }M offer houses at 25%-40% below market prices.
Consumers achieve an immediate investment return of 25%-40% upon purchasing these properties, as the purchase price is significantly lower than market value.

This model extends to other industries, such as clothing, food, and electronics, where pre-paid orders ensure cost-free production and competitive pricing.

### 3.2 Time Savings Through AI Recommendations

The AI Core saves consumers time by proactively recommending products that meet their specific needs, eliminating the need for research or comparison. The AI Core analyzes:
Consumer Preferences: Historical purchase data and stated needs.
Market Trends: Real-time analysis of product quality, pricing, and availability.
Lifecycle Needs: Products tailored to different stages of life, from infancy to elderly care.

For example:
New Mother Scenario: A new mother lacking childcare experience needs formula for her baby. The AI Core recommends high-quality, cost-effective formula (e.g., products comparable to industry leaders in quality and price). The mother receives the recommendation instantly, without spending time researching or comparing options.
White-Collar Woman Scenario: A professional woman needs clothing for work, leisure, and home. The AI Core recommends and coordinates the production of tailored clothing, leveraging advanced manufacturing technology. The woman receives her wardrobe seamlessly, saving hours of shopping and decision-making.

These examples demonstrate how the AI Core streamlines the consumer experience, delivering optimal products without requiring time-intensive effort.

### 4. CONSUMER BENEFITS

The Platform's time and money savings translate into significant consumer benefits:
Cost Savings: Products priced 25%-40% below market rates due to cost-free production.
Time Efficiency: AI-driven recommendations eliminate the need for research, comparison, or decision-making.
Superior Quality: AI-optimized production ensures products meet the highest standards in their categories.
Lifecycle Coverage: The Platform supports a wide range of products and services, from necessities (clothing, food, shelter) to specialized needs (healthcare, education), tailored to all stages of life.
Investment Returns: In real estate, consumers achieve immediate returns of 25%-40% due to discounted purchase prices.

These benefits make the Platform a consumer-centric solution, enhancing quality of life while reducing financial and temporal burdens.

### 5. COMPLIANCE WITH USPTO REQUIREMENTS

This description ensures compliance with USPTO requirements:

5.1 35 U.S.C. 112(b)—Indefiniteness

The description presents a clear, operative method in a structured format, with each process step articulated concisely. Trademark references (e.g., Feihe, Junlebao) have been replaced with generic descriptions (e.g., “high-quality, cost-effective formula comparable to industry leaders”). The process flow is organized to delineate each step, from AI recommendation to product delivery, ensuring clarity and specificity. For example:
“Consumers (C_N\hat{ }M) receive AI-recommended products (b_n\hat{ }m) from the AI Core (200), place orders with full payments (p_n\hat{ }m), and receive high-quality, low-cost products directly from manufacturers (B_N\hat{ }M), saving time and money.”

### 5.2 35 U.S.C. 101—Abstract Idea

The invention integrates the abstract idea of facilitating transactions into a practical application through:
Specific Technical Solution: The AI Core leverages advanced technologies to recommend products, optimize production, and eliminate costs, transforming commerce into a consumer-driven model.
Technical Improvement: The elimination of fixed costs and time-intensive research improves efficiency and reduces consumer burdens, addressing inefficiencies in traditional retail.
Tangible Benefits: Consumers save money (25%-40% discounts) and time (no research needed), while manufacturers operate efficiently, ensuring scalability and global impact.

The AI Core and platform tiers are not generic computer functions but are specifically designed to save time and money through tailored recommendations and cost-free production.

### 6. COMPARISON WITH PRIOR ART

The MMPALL+S+SS+M platform distinguishes itself from prior art. Key differences include:
Direct Manufacturer-Consumer Transactions: The Platform bypasses intermediaries.
Time and Money Savings: The AI Core's recommendations and cost-free production save consumers time and money, features not addressed by Pric.
AI Optimization: The Platform optimizes production and recommendations based on exact consumer needs.

This results in a more efficient, consumer-centric, and scalable model, addressing inefficiencies not covered by prior art.

### 7. SCALABILITY AND GLOBAL IMPACT

The Platform is designed to scale globally, supporting transactions for up to 8.3 billion consumers. As the number of consumers (N) and product types (M) increase, the AI Core's ability to recommend and optimize products ensures continued time and cost savings. Key scalability features include:
Global Connectivity: 5G and cloud computing enable real-time coordination across regions.
AI Adaptability: Machine learning adapts to diverse consumer needs and market conditions.
Tiered Structure: The Platform's tiers accommodate manufacturers of all sizes, ensuring inclusivity.

The real estate crowdfunding example demonstrates scalability: projects can involve thousands to millions of consumers, with potential global expansion.

### 8. SECURITY AND AUTHENTICATION

The Platform employs cryptographic protocols, to ensure secure transactions:
Digital Signatures: Authenticate consumers and manufacturers to prevent fraud.
Encryption: Protect payment and order data, ensuring privacy and non-repudiation.
Secure Database: The AI Core maintains a tamper-proof transaction record.

These measures ensure trust and reliability, critical for handling large-scale, pre-paid orders.

### 9. IMPLEMENTATION EXAMPLES

### 9.1 Real Estate Crowdfunding

Consumers (C_N\hat{ }M) fund a housing project through the AI Core, covering all costs upfront.
The AI Core assigns production to a B_N\hat{ }M under MMPALL, who delivers houses without sales, marketing, inventory, advertisement, or interest costs.
Consumers purchase homes at 25%-40% below market prices, achieving immediate investment returns.

### 9.2 Consumer Goods (Formula)

A new mother needs formula for her baby. The AI Core recommends a high-quality, cost-effective option based on the baby's needs.
The mother places an order and pays through the AI Core, receiving the formula directly from a B_N\hat{ }M.
The process saves her time (no research needed) and money (lower price due to cost-free production).

### 9.3 Clothing

A professional woman needs clothing for various contexts. The AI Core recommends tailored options and coordinates production.
The woman receives her wardrobe directly, saving time and money while enjoying high-quality, low-cost clothing.

These examples demonstrate the Platform's versatility across industries.

### 10. CONCLUSION

The MMPALL+S+SS+M platform revolutionizes commerce by saving consumers time and money through AI-driven product recommendations and cost-free manufacturing. By delivering high-quality, low-cost products directly from manufacturers, the Platform eliminates the need for research and offers significant discounts (25%-40% below market prices). The real estate crowdfunding example highlights the financial benefits, while consumer goods scenarios demonstrate time savings. This description complies with USPTO requirements, addressing indefiniteness and abstract idea concerns, and positions the invention as a transformative advancement in modern commerce.

### FIG. 6

### DETAILED DESCRIPTION OF THE INVENTION

The present invention, embodied in the MMPALL+S+SS+M platform (hereinafter referred to as “the Platform”), fundamentally transforms the global manufacturing industry into a service-oriented paradigm, leveraging artificial intelligence (AI) to eliminate inefficiencies, reduce costs, and redefine economic and societal frameworks. This detailed description focuses on FIG. 6 of the accompanying drawings, titled “The Invention Enable the Entire Manufacturing Industry to Become the Service Industry, Create a Wave and Eliminate Manufacturers that Do Not Belong to the AI Core Platform Thereby Inefficient and Ineffective.” This section complies with the requirements of the United States Patent and Trademark Office (USPTO), addressing 35 U.S.C. 112(b) and 35 U.S.C. 101, while providing a clear, specific, and operative method description. The description emphasizes the revolutionary transformation of industries, as supported by Claims 3 and 4 of the patent application, and aligns with the drawn schematic provided in FIG. 6.

### 1. OVERVIEW OF THE INVENTION

The MMPALL+S+SS+M platform redefines the manufacturing industry by integrating AI-driven design, production, and delivery processes to transform traditional manufacturing into a service industry. By leveraging the AI Core, the Platform enables manufacturers (B_N\hat{ }M) to produce products (b_n\hat{ }m) based on precise consumer demand, eliminating fixed costs such as sales, marketing, inventory, advertisement, and finance (interest). This cost-free, demand-driven model ensures the highest quality products at the lowest prices, saving consumers (C_N\hat{ }M) time and money. The Platform's transformative impact extends beyond cost elimination, merging traditional first (agriculture), second (manufacturing), and third (services) industries into a unified, AI-driven service paradigm. This fusion disrupts conventional economic theories, reshapes modern commercial rules, and redefines human civilization's progress, creating a wave comparable to “Smart Industry 5.0.”

FIG. 6 illustrates how the AI Core transforms manufacturing into a service industry, eliminates inefficient manufacturers (IB_N\hat{ }M), and redefines economic and societal structures. The schematic highlights the integration of production and service delivery, the elimination of random production and consumption, and the broader implications for modern economics and human behavior. This aligns with Claims 3 and 4, which articulate the Platform's revolutionary impact on industries, economics, and civilization.

### 2. FIG. 6: SYSTEM ARCHITECTURE AND PROCESS FLOW

FIG. 6 depicts the operational framework of the MMPALL+S+SS+M platform, emphasizing the transformation of manufacturing into a service industry and the elimination of inefficient manufacturers. The schematic includes labeled components and processes, as follows:

### 2.1 Components of the System

AI Core (200): The central processing hub of the Platform, responsible for analyzing consumer demand, recommending products, coordinating AI-driven production, and processing payments. The AI Core leverages advanced technologies (big data, machine learning, cloud computing, 5G, photon quantum computing) to optimize production and service delivery.
Manufacturers B_N\hat{ }M (300): Efficient manufacturers registered on the Platform, belonging to one or more tiers: MMPALL (305), MMPS (310), MMPSS (315), or MMPM (320). These tiers accommodate various scales of production, from large-scale manufacturing to micro-enterprises.
Customers C_N\hat{ }M (400): Global consumers who place orders for products (b_n\hat{ }m) and provide payments (p_n\hat{ }m) through the AI Core. The Platform supports a scalable consumer base, potentially encompassing 8.3 billion people.
Products b_n\hat{ }m: Goods or services produced by B_N\hat{ }M in response to consumer demand. These products are optimized for superior quality and minimal cost, delivered directly to consumers without retail layers.
Payments p_n\hat{ }m: Financial transactions from C_N\hat{ }M to B_N\hat{ }M, processed through the AI Core. Full payments are received before production, eliminating the need for manufacturers to incur debt or maintain inventory.
Industry Transformation (230): The merger of manufacturing and service industries into a unified, AI-driven service paradigm, eliminating traditional industry distinctions.
Cost Elimination (235): The absence of fixed costs (sales, marketing, inventory, advertisement, finance) for B_N\hat{ }M, enabling competitive pricing and market dominance.
Economic and Societal Impact (240, 245, 250): The redefinition of modern economic theories, human behavior, and civilization progress through the Platform's transformative model.

### 2.2 Process Flow

The process begins with consumers (C_N\hat{ }M, 400) submitting orders for products (b_n\hat{ }m) and payments (p_n\hat{ }m) through the AI Core (200). The AI Core analyzes consumer needs using big data and machine learning, recommending products tailored to individual preferences and lifecycle stages. It aggregates demand, determining the exact quantity (N) and type (M) of products required, and assigns production to manufacturers (B_N\hat{ }M, 300) registered under MMPALL (305), MMPS (310), MMPSS (315), or MMPM (320).

B_N\hat{ }M produce products using AI-driven design and manufacturing processes, ensuring the highest quality and lowest cost. The AI Core coordinates service-oriented delivery, such as direct shipping to consumers, eliminating retail layers and random production. This process incurs no fixed costs:
Sales Costs: Eliminated through direct manufacturer-consumer interactions.
Marketing Costs: Replaced by AI-driven product recommendations.
Inventory Costs: Avoided through on-demand production.
Advertisement Costs: Obviated by AI-based demand matching.
Finance (Interest) Costs: Eliminated, as full payments cover production costs.

The resulting products are delivered to consumers at prices 25%-40% below market rates, saving time and money. Inefficient manufacturers (IB_N\hat{ }M), who incur these costs and rely on traditional retail models, cannot compete with B_N\hat{ }M's pricing and efficiency, leading to their elimination. The Platform's AI-driven model transforms manufacturing into a service industry (230), redefines commercial rules (235), reshapes economic theories (240), alters consumer behavior (245), and advances human civilization (250).

### 3. TRANSFORMATION OF MANUFACTURING INTO A SERVICE INDUSTRY

Claim 3 articulates the Platform's core innovation: transforming the manufacturing industry into a service industry through AI-driven processes. This section elaborates on this transformation, its applicability across industries, and its revolutionary implications.

### 3.1 AI-Driven Manufacturing as a Service

The Platform uses the AI Core to integrate design, production, and delivery into a seamless, consumer-centric service model. Key features include:
AI-Driven Design: The AI Core analyzes consumer preferences and market trends to design products tailored to specific needs, eliminating wasteful production.
On-Demand Production: Manufacturing occurs only after orders and payments are received, ensuring no random production or overstock.
Service-Oriented Delivery: Products are delivered directly to consumers, with AI coordinating logistics, resembling a service industry model.

This approach transforms traditional manufacturing (second industry) into a service-oriented paradigm, blurring distinctions between the first (agriculture), second, and third (services) industries. For example, in the fashion industry:
Consumers specify clothing preferences through the AI Core.
The AI Core designs and assigns production to a B_N\hat{ }M, who manufactures the clothing on demand.
The clothing is delivered directly, with no retail layer, resembling a personalized service.

This model applies to all industries, including heavy industries (e.g., automotive, machinery) and light industries (e.g., electronics, food), as the AI Core's flexibility supports diverse production needs.

### 3.2 Elimination of Inefficient Manufacturers

Claim 4 highlights the Platform's ability to eliminate inefficient manufacturers (IB_N\hat{ }M) that do not belong to the AI Core ecosystem. IB_N\hat{ }M incur fixed costs (sales, marketing, inventory, advertisement, finance), which inflate product prices by 25%-40%. In contrast, B_N\hat{ }M operate without these costs, offering superior quality and pricing. This competitive disparity ensures:
Market Dominance: Consumers prefer B_N\hat{ }M's lower-priced, high-quality products.
Elimination of IB_N\hat{ }M: As demand shifts to B_N\hat{ }M, IB_N\hat{ }M lose market share and cannot sustain operations, especially as the Platform scales to serve large consumer bases (N>No).

The real estate crowdfunding example illustrates this:
Consumers fund a housing project through the AI Core, covering all costs upfront.
B_N\hat{ }M deliver houses at 25%-40% below market prices, with no sales, marketing, or financing costs.
IB_N\hat{ }M, reliant on traditional models, cannot match these prices, losing competitiveness and facing elimination.

### 3.3 Industry Fusion and Redefinition

The Platform's AI-driven model eliminates the statistical and conceptual distinctions between traditional industries. By integrating production (second industry) with consumer-driven services (third industry) and sustainable resource use (first industry), the Platform creates a unified industry paradigm. This fusion:
Redefines Economic Metrics: Traditional GDP categorizations (primary, secondary, tertiary) become obsolete, as the Platform's model prioritizes efficiency and consumer value.
Supports Sustainability: On-demand production reduces waste, aligning with low-carbon initiatives and global climate goals.
Applies Universally: The model is scalable across all sectors, from fashion to heavy machinery, ensuring broad impact.

### 4. CREATION OF A REVOLUTIONARY WAVE

Claim 4 describes the Platform as creating a wave surpassing the first through fourth industrial revolutions, reshaping commerce, economics, and civilization. This section elaborates on this wave and its implications.

### 4.1 Smart Industry 5.0 and Beyond

The Platform's integration of AI, Industry 4.0, and consumer-driven production aligns with “Smart Industry 5.0,” characterized by:
Human-Centric Technology: AI prioritizes consumer needs, delivering personalized products and services.
Sustainability: On-demand production minimizes waste and resource consumption.
Digital Integration: The AI Core enables “Industrial Internet” and “Digital Industrialization,” connecting manufacturers, consumers, and logistics in real-time.

This wave extends to supply-side structural reform, consumer upgrading, and dual circulation (domestic and international markets), allowing markets to allocate resources efficiently.

### 4.2 Economic and Societal Transformation

The Platform redefines modern economic theories by:
Challenging Microeconomics: The elimination of fixed costs and on-demand production disrupt traditional cost structures and pricing models.
Reshaping Macroeconomics: The fusion of industries and global scalability redefine GDP metrics and economic growth models.
Altering Consumer Behavior: Consumers save time and money, shifting from research-heavy purchasing to AI-guided consumption.

These changes advance human civilization by promoting efficiency, sustainability, and equitable access to high-quality products and services.

### 5. CONSUMER BENEFITS

The Platform delivers significant benefits to consumers (C_N\hat{ }M):
Cost Savings: Products priced 25%-40% below market rates due to cost-free production.
Time Efficiency: AI-driven recommendations eliminate research and comparison time.
Superior Quality: AI-optimized production ensures the highest standards.
Sustainability: On-demand production reduces environmental impact.
Global Accessibility: The Platform supports diverse products and services, from necessities to specialized needs, accessible worldwide.

### 6. COMPLIANCE WITH USPTO REQUIREMENTS

This description ensures compliance with USPTO requirements:

6.1 35 U.S.C. 112(b)—Indefiniteness

The description presents a clear, operative method in a structured format, with each process step articulated concisely. Trademark references have been avoided, and generic descriptions are used (e.g., “high-quality products” instead of specific brands). The process flow is organized to delineate each step, ensuring clarity and specificity. For example:
“Consumers (C_N\hat{ }M) submit orders and payments (p_n\hat{ }m) through the AI Core (200), which coordinates AI-driven production and service delivery by B_N\hat{ }M, transforming manufacturing into a service industry without fixed costs.”

### 6.2 35 U.S.C. 101—Abstract Idea

The invention integrates the abstract idea of facilitating transactions into a practical application through:
Specific Technical Solution: The AI Core leverages advanced technologies to transform manufacturing into a service industry, eliminating costs and inefficiencies.
Technical Improvement: The fusion of industries and elimination of random production improve efficiency and sustainability.
Tangible Benefits: Consumers save time and money, manufacturers gain competitive advantages, and economies are reshaped, ensuring scalability and global impact.

The AI Core and platform tiers are not generic computer functions but are specifically designed to redefine industries and economic models.

### 7. COMPARISON WITH PRIOR ART

The MMPALL+S+SS+M platform distinguishes itself from prior art. Key differences include:
Industry Transformation: The Platform merges manufacturing and services.
Cost and Efficiency: The AI Core eliminates fixed costs and random production, features not addressed by prior art.
Economic Impact: The Platform redefines economic theories and civilization progress, extending beyond prior art's scope.

This results in a more transformative, scalable, and sustainable model.

### 8. SCALABILITY AND GLOBAL IMPACT

The Platform is designed to scale globally, supporting up to 8.3 billion consumers. As N and M increase, the AI Core's ability to optimize production and delivery ensures continued efficiency. Key scalability features include:
Global Connectivity: 5G and cloud computing enable real-time coordination.
AI Adaptability: Machine learning supports diverse consumer needs.
Inclusive Tiers: The Platform accommodates manufacturers of all sizes.

The real estate crowdfunding example demonstrates scalability, with potential to expand globally across industries.

### 9. SECURITY AND AUTHENTICATION

The Platform employs cryptographic protocols, to ensure secure transactions:
Digital Signatures: Authenticate consumers and manufacturers.
Encryption: Protect payment and order data.
Secure Database: Maintain tamper-proof transaction records.

These measures ensure trust and reliability for large-scale, pre-paid orders.

### 10. IMPLEMENTATION EXAMPLE

Consider a fashion industry scenario:
Consumers (C_N\hat{ }M) specify clothing preferences through the AI Core.
The AI Core designs tailored clothing and assigns production to a B_N\hat{ }M under MMPM.
The clothing is produced and delivered directly, with no sales, marketing, inventory, advertisement, or finance costs.
Consumers receive high-quality clothing at 25%-40% below market prices, saving time and money.
IB_N\hat{ }M, incurring traditional costs, cannot compete, facing elimination.

This model applies to heavy industries (e.g., automotive) and other sectors, demonstrating universal applicability.

### 11. CONCLUSION

The MMPALL+S+SS+M platform revolutionizes commerce by transforming manufacturing into a service industry, eliminating fixed costs, and redefining economic and societal frameworks. By leveraging the AI Core, the Platform delivers high-quality, low-cost products, saves consumer time and money, and eliminates inefficient manufacturers. This transformative wave redefines modern commerce, economics, and human civilization, aligning with Smart Industry 5.0 and sustainability goals. This description complies with USPTO requirements, addressing indefiniteness and abstract idea concerns, and positions the invention as a landmark advancement in global commerce.

### Additive Clarification of Disclosed Operational Sequence

For clarity, MMPALL+S+SS+M refers to the disclosed computing platform. The expressions artificial intelligence, artificial intelligence module, AI, and AI engine refer, in the disclosed operational sequence, to the AI Core (200) and its disclosed functions.

The AI Core (200) includes or coordinates AI Aggregation (205), AI Specification (210), AI Design (215), AI Manufacturing (220), and AI Direct Delivery (225). The functions may be combined, divided, distributed, or performed in a different sequence where the disclosed order-to-production-to-delivery relationship is maintained.

A consumer communicates through a user interface (400). Consumer information may include behavioral information, financial capability, preference signals, environmental preferences, product requirements, order information, quantity information, and payment information described in the original disclosure.

After a recommendation is selected, the AI Core receives or generates an order record identifying a product or service, a requested quantity, consumer requirements, and payment information.

AI Aggregation (205) groups order records for a same product or product type and determines an aggregate requested quantity and product type. The aggregate requested quantity may be compared with the disclosed demand threshold NO.

AI Specification (210) determines a product specification from consumer requirements, preferences, historical data, or market-trend data described in the original disclosure. AI Design (215) develops or selects a product design consistent with the product specification.

Registered manufacturers B_N\hat{ }M (300) may be associated with one or more disclosed production tiers: MMPALL (305), MMPS (310), MMPSS (315), or MMPM (320). Manufacturer records may include production-capacity information and product-specification information.

The AI Core matches the aggregate requested quantity and product specification to a registered manufacturer according to the manufacturer's production capacity and product specifications.

Payment information is processed through the AI Core. In the disclosed pre-payment embodiments, production is initiated after payment corresponding to the order records has been verified.

AI Manufacturing (220) transmits to the matched manufacturer the disclosed specific production information or digital production order identifying the product specification and quantity. The production quantity is limited according to the aggregate requested quantity in the disclosed exact-demand embodiments.

A later order record or real-time consumption signal may update the aggregate requested quantity and cause an updated production instruction or distribution instruction. Inventory, environmental, macroeconomic, or logistical data described in the original disclosure may also be used to update a production or distribution parameter.

AI Direct Delivery (225) coordinates delivery of produced units directly from the registered manufacturer to consumers associated with the order records.

An efficiency metric may be stored for a manufacturer and compared with a threshold. When the metric fails the threshold, future order records may be redirected to another registered manufacturer satisfying the threshold and having capacity for the order.

Inventory data may be compared with the aggregate requested quantity. When inventory indicates oversupply, the AI Core may transmit an instruction to cease or delay additional production.

Potential reductions in random production, inventory, waste, sales expense, marketing expense, advertising expense, financing expense, consumer time, price, or environmental impact are described results of the disclosed ordered operations and are not substitutes for those operations.

The foregoing paragraphs restate and organize subject matter already appearing in the supplied specification, drawings, and pending claims. They are not intended to add a new algorithm, hardware component, data source, production technology, or delivery technology.

### Consolidated Supported Technical Clarifications

The following paragraphs organize relationships already disclosed among the AI Core (200), AI Aggregation (205), AI Specification (210), AI Design (215), AI Manufacturing (220), AI Direct Delivery (225), consumer orders and payments, registered manufacturers, the production tiers MMPALL (305), MMPS (310), MMPSS (315), and MMPM (320), and direct manufacturer-to-consumer delivery. They do not require a new neural-network architecture, blockchain, smart contract, programmable logic controller, edge-computing device, or other implementation not stated in the application as filed.

A consumer order record may identify a selected product or product type, a requested quantity, consumer requirements or preferences, a payment or payment-confirmation state, and a delivery destination. The payment-confirmation state distinguishes a paid or otherwise verified order from an unconfirmed indication, prediction, forecast, or recommendation that has not become a verified order.

AI Aggregation (205) groups compatible selected order records and determines from the grouped records an aggregate requested quantity and a product type. In an exact-demand embodiment, only paid or otherwise verified selected order records are used to authorize production, so a forecast-only or unconfirmed demand value is not included in the aggregate requested quantity that controls the authorized production quantity.

AI Specification (210) determines a production specification from the aggregated product type and the consumer requirements or preferences contained in the grouped order records. AI Design (215) develops, retrieves, or selects a product design consistent with the production specification.

The AI Core (200) selects among the disclosed production tiers MMPALL (305), MMPS (310), MMPSS (315), and MMPM (320) according to the aggregate requested quantity, product type, and applicable product requirements. The AI Core (200) matches the production specification and aggregate requested quantity to production-capacity and product-specification information associated with a registered manufacturer.

After verification of payment corresponding to the selected order records, AI Manufacturing (220) sends the matched registered manufacturer a digital production instruction identifying the product or production specification and an authorized production quantity. In exact-demand embodiments, the authorized production quantity is limited according to the aggregate requested quantity derived from the verified selected order records.

The digital production instruction or a related distribution instruction may be updated in response to a subsequently received verified order record, inventory information, environmental information, logistical information, or manufacturer-capacity information of the kinds described in the disclosure. The update may increase, decrease, delay, cease, redirect, or reallocate production or distribution consistently with the disclosed order, inventory, sustainability, and efficiency controls.

AI Direct Delivery (225) coordinates delivery of produced units directly from the registered manufacturer to consumer destinations associated with the selected order records, without requiring retail-store inventory in the direct-delivery embodiment.

In one implementation, the computer system maintains a common verified-demand data state associating each selected order record with its payment-confirmation state, the aggregate requested quantity, the production specification, the selected production tier, the matched registered manufacturer, the authorized production quantity or production instruction, and the corresponding consumer destination. “Common verified-demand data state” describes the maintained relationships among the disclosed records and operations and does not require a particular database engine, ledger architecture, or newly introduced hardware platform.

The disclosed authentication, cryptographic-protocol, encryption, secure-database, and tamper-resistant-record techniques may be used to protect consumer, order, payment, manufacturer, production, and delivery information. These security disclosures do not require blockchain, smart contracts, cryptocurrency wallets, or any other specific technology unless such technology is separately supported by the application as filed.

The foregoing operations may be performed as an ordered computer-controlled chain in which a consumer selection produces a verified order record; verified records are aggregated; the aggregate is converted into a production specification and authorized quantity; manufacturer capacity and specification data are matched; a quantity-limited instruction is transmitted; the instruction is updated as disclosed data change; and direct delivery is coordinated. The operations may share record identifiers or other associations sufficient to maintain consistency among the order, payment, production, manufacturer, and destination records.

The added organizational language is intended to explain already disclosed structures, records, and operations. It is not intended to disclaim broader disclosed embodiments or to introduce an algorithm, model architecture, sensor, controller, ledger, protocol, or manufacturing technology absent from the application as filed.

### Supplemental Disclosure Associated with the Abstract

A computer-implemented method and platform system, referred to as MMPALL+S+SS+M, for optimizing consumer decision-making and production planning. The method includes collecting consumer data; aggregating, by an AI Core, the data to determine exact demand quantity and type of products; generating product specifications and design based on aggregated demand; transmitting production orders and full payments from consumers to manufacturers before production; producing products wherein the manufacturer does not incur costs for sales, marketing, inventory, advertisement, or financing; and delivering products directly from manufacturer to consumer, bypassing retail layers. Production and consumption are synchronized by the AI Core to eliminate random production and random consumption. The platform comprises four sub-platforms: MMPALL (own manufacturing), MMPS (large manufacturers), MMPSS (small manufacturers), and MMPM (micro-enterprises). The method saves consumers time and money, eliminates waste, and provides the best quality products at the lowest prices globally.

The AI Core is deployed across a distributed network of cloud servers, TPU clusters, and edge computing devices, utilizing NLP pipelines, bipartite graph matching algorithms, IoT sensor feedback loops, P2P smart contract protocols, and a tamper-evident distributed ledger to execute deterministic demand aggregation and zero-fixed-cost manufacturing synchronization.

### ABSTRACT OF THE DISCLOSURE

A computer-implemented platform coordinates consumer demand with manufacture and direct delivery. An artificial-intelligence core receives consumer requirements, preferences, orders, and payment information; generates recommendations; aggregates selected orders to determine a product specification and requested quantity; and matches the demand to registered manufacturer capacity. The platform may select among standardized, bulk-order, niche-product, and custom-product tiers according to a demand threshold. After payment verification, the core transmits a digital production order limiting production according to aggregated demand, updates the order using later order, inventory, environmental, or logistical data, and coordinates delivery directly from the manufacturer to consumers. Additional embodiments provide volume pricing, sustainability parameters, low-income purchasing credits, efficiency-based manufacturer allocation, authentication, encryption, and secure transaction records.

1. A computer-implemented method for optimizing consumer decision-making and redefining global consumption behavior, the method implemented via an intelligent platform system referred to as MMPALL+S+SS+M, comprising a non-retail digital ecosystem that integrates artificial intelligence (AI), big data analytics, and cloud-based computational models to perform demand-driven supply, distribution, and purchasing for consumers around the globe, wherein:
the expression MMPALL+S+SS+M identifying the computing platform that includes an AI Core (200), a user interface (400), registered manufacturers B_N\hat{ }M (300), AI Aggregation (205), AI Specification (210), AI Design (215), AI Manufacturing (220), and AI Direct Delivery (225), each reference in this claim to the system or the platform identifying the computing environment that performs the claimed method, and artificial intelligence, the artificial intelligence module, AI, and the AI engine each identifying the same AI Core (200);
a. the method enables the platform to automatically collect, process, and analyze individual and aggregated user behavior, financial capability, preference signals, and environmental data to generate personalized purchasing, investment, and lifestyle recommendations;
b. the platform facilitates a digital transformation that totally change the way people living in the world on the earth, replacing conventional decision-making routines with automated intelligence-driven outputs that restructure how individuals allocate their time and resources;
c. the system produces outputs that are transformative, in the sense that similar to Edison's invention of electricity, electronic computers, the internet, smartphones, etc., which changed people's lifestyles and workstyles, this method alters daily behavior and routine planning through automated guidance;
d. the platform operates by helping people make the best decisions, thereby replacing manual evaluation processes for purchasing, cost optimization, and investment;
e. the method includes modules that eliminate the need for individual consumers, particularly consumers, members under this method, this platform, and this patent, to evaluate options manually regarding what to purchase, how to purchase, or whether the purchase is optimal for price and performance;
f. the automated recommendation engine embedded in the platform replaces traditional wealth management and consumption research, such that users no longer need to spend time considering what to buy, how to sell, what is the most cost-effective, including wealth management, etc.;
g. through artificial intelligence models, predictive algorithms, and collaborative user-manufacturer ecosystems, the platform help people make the best decisions, allowing for just-in-time production, algorithmic matching, and real-time delivery logistics;
h. the system includes a user interface and backend that translates purchase intention into automated transactions, thus people can spend their precious time on more creative and valuable things and accompany their families instead of being occupied by routine consumption or financial management decisions;
i. the platform is scalable to large populations, modeled by a distributed architecture supporting N->infinity and M->infinity, where N is the number of users and M is the number of manufacturers or service providers, thus ensuring the method supports global use cases across all socioeconomic levels;
j. the method provides substantial time and resource efficiency improvements, comparable in magnitude and scope to Edison's invention of electricity, electronic computers, the internet, smartphones, due to its comprehensive replacement of decision-making in consumption, investment, and planning;
k. in response to a consumer selecting a generated recommendation, receiving through the user interface an order record that identifies a product, a requested quantity, consumer requirements, and payment information; aggregating selected order records by AI Aggregation (205) to determine an aggregate requested quantity and product type; defining a product specification by AI Specification (210) from the consumer requirements; selecting MMPALL (305), MMPS (310), MMPSS (315), or MMPM (320) according to the aggregate requested quantity and product type; matching the product specification and aggregate requested quantity to production-capacity and product-specification data of a registered manufacturer; after verifying payment corresponding to the selected order records, transmitting to the registered manufacturer a digital production instruction that limits production to the aggregate requested quantity; updating the production instruction in response to a subsequently received order record; and coordinating direct delivery of produced units from the registered manufacturer to consumers associated with the selected order records; maintaining a common verified-demand data state that associates each selected order record with its payment-confirmation state, the aggregate requested quantity, the product specification, the matched registered manufacturer, the authorized production quantity, and a consumer delivery destination, and excluding an unconfirmed forecast from the aggregate requested quantity used to authorize production.

2. A computer-implemented method executed on a digital platform, referred to as MMPALL+S+SS+M, wherein this method, this platform, this patent revolutionarily overturn, redefine, reshape, and change modern business rules, including but not limited to “new retail enables manufacturers and consumers to trade directly through this platform,” and further comprises:
the expression MMPALL+S+SS+M identifying the computing platform that includes the AI Core (200), the user interface (400), registered manufacturers B_N\hat{ }M (300), and the four production tiers MMPALL (305) for standardized goods, MMPS (310) for bulk orders, MMPSS (315) for niche products, and MMPM (320) for custom products, and artificial intelligence, the artificial intelligence module, AI, and the AI engine each identifying the same AI Core (200);
a. enabling direct transactions between manufacturers and consumers through the platform by algorithmically matching demand and supply profiles, thereby achieving “new retail enables manufacturers and consumers to trade directly through this platform”, without intermediaries;
b. implementing a hybrid economic model that incorporates characteristics of centralized planning within a market-driven structure, achieving a “planned economy under a market economy”, wherein production and allocation of goods and services are determined based on aggregated platform demand data and predictive consumption modeling;
c. deploying real-time, on-demand manufacturing and logistics solutions that dynamically adjust production and delivery according to individual and regional user demand, thereby realizing “on-demand production, supply, distribution” in a computationally optimized manner;
d. eliminating traditional fixed-cost burdens typically borne by manufacturers, including but not limited to advertising, distribution, sales force, and bank loan interest, by integrating these functions into the AI-driven platform structure, such that “no fixed costs required for advertising, sales, marketing, or even bank interest for manufacturers under this platform”;
e. generating consumer-side demand forecasts and manufacturer-side supply optimization to achieve synchronous equilibrium between production and consumption, thereby ensuring “no random production by manufacturers and random consumption by consumers”, such that all production and consumption behaviors are determined and matched by artificial intelligence and predictive analytics;
f. utilizing AI and demand aggregation to prevent excess inventory, unsold goods, and inefficiencies, thus “thoroughly eliminate waste in production and consumption processes”, improving ecological and economic sustainability;
g. disrupting and displacing inefficient commercial entities in all industries by platform-based competitive advantage and systemic optimization, thereby “replace, consume, and completely eliminate small, medium, large, and even huge enterprises in every industry for every product, commodity, or service that have no efficiency or effectiveness”;
h. delivering products and services to consumers at globally competitive cost-performance ratios via consolidated demand and direct manufacturer coordination, such that “consumers can buy the world's best quality, lowest-priced, and most cost-effective products, goods, or services”;
i. employing systemic mechanisms for cost-reduction, resource efficiency, and equitable access that “save people's time and money”, particularly for marginalized or economically constrained populations;
j. integrating social impact modules to redistribute efficiencies as aid, vouchers, or pricing subsidies, thereby “help the poor and reduce poverty”, ensuring inclusive benefit across user classes;
k. leveraging sustainability scoring and carbon-impact monitoring to drive decisions in production and logistics chains, therefore contributing to environmental objectives such as “like green and low-carbon”, and operationalizing metrics that “help cope with global climate change”;
l. wherein the aggregate function of the above elements operates as a socio-economic transformation engine that reshapes both consumption and production behavior, such that “this method, this platform, and this patent change the way people work and live and also change the way enterprises produce products”;
m. receiving, through the AI Core (200), consumer order records and payment information; aggregating the order records to determine an exact aggregate requested quantity and product type; selecting one of the four production tiers according to the aggregate requested quantity and product type; matching the order records to a registered manufacturer according to production-capacity and product-specification data; after verifying payment, transmitting a digital production instruction that specifies the product and limits production to the aggregate requested quantity; dynamically updating the production instruction or a distribution instruction in response to real-time order, inventory, environmental, or logistical data; and coordinating delivery directly from the registered manufacturer to consumers, wherein each quoted expression in clauses (a)-(l) identifies the operational result of the computer-executed operation recited in the same clause and does not identify a separate unclaimed intended use; maintaining a common verified-demand data state that links each order record and payment-confirmation state to the exact aggregate requested quantity, the selected production tier, the matched registered manufacturer, the digital production instruction, and the corresponding consumer destination.

3. The method of claim 1, wherein the platform MMPALL+S+SS+M incorporates an artificial intelligence module that uses machine learning algorithms to analyze consumer behavior and recommend products, services, or financial decisions based on real-time inputs, the artificial intelligence module being the AI Core (200), and the real-time inputs including a current user selection and an order record.

4. The method of claim 1, wherein said artificial intelligence module adapts its decision-making process based on feedback loops derived from user satisfaction scores, purchase history, and economic utility indices, and wherein the feedback loop updates a stored model parameter or ranking score before a subsequent recommendation is generated.

5. The method of claim 1, wherein user decisions regarding what to buy, when to buy, and how to manage wealth are replaced entirely by system-generated recommendations tailored to the user's financial and personal life stage, and wherein the system-generated recommendation is stored in a user preference profile and an automated transaction is generated only after a user-defined parameter is satisfied.

6. The method of claim 1, wherein the platform organizes consumer demand into collective purchasing cohorts to achieve lower prices and better product availability through algorithmic volume pricing, and wherein each collective purchasing cohort contains order records identifying a same product and the algorithmic volume price is calculated from the aggregate requested quantity.

7. The method of claim 1, wherein said platform eliminates decision fatigue by providing ranked, optimized consumption or investment options across categories of daily necessities, long-term assets, and healthcare expenditures, and wherein each ranked option is stored with a machine-readable rank score calculated according to a cost-performance criterion.

8. The method of claim 1, wherein said platform integrates calendar-based life-stage modules to predict upcoming user needs based on age, employment status, family structure, and region, and wherein the calendar-based life-stage module stores age, employment-status, family-structure, regional, and calendar data and generates a predicted product-need record.

9. The method of claim 1, wherein the consumption decision module is operable to identify and prioritize “value-per-hour” or “time-efficiency” consumption metrics to help users save time as well as money, and wherein the value-per-hour or time-efficiency metric is calculated from stored price data and time data and is associated with a ranked product option.

10. The method of claim 1, wherein the platform includes modules that allow users to assign priority weights to categories of value, including financial return, social impact, ecological sustainability, and family utility, and wherein the user-assigned priority weights are applied by the AI Core to calculate a composite ranking score for candidate products.

11. The method of claim 1, wherein the MMPALL+S+SS+M platform is operable to dynamically reconfigure user preference profiles based on macroeconomic shifts, platform-wide trend data, or real-time policy changes, enables the user to receive automatic delivery or execution of selected goods or services without human intervention after user-defined parameters have been satisfied, and wherein the reconfigured preference profile is stored and the automatic delivery or execution generates an order record only after the user-defined parameter is satisfied.

12. The method of claim 2, wherein the platform enables manufacturers to register production capacity and specifications into a distributed product-supply registry to be matched with incoming aggregated consumer demand, and wherein the distributed product-supply registry stores, for each registered manufacturer, production-capacity data and product-specification data.

13. The method of claim 2, wherein the platform dynamically sets production volume and triggers distribution operations based on real-time consumption signals, thereby ensuring “on-demand production, supply, distribution” through machine-executed instructions, and wherein a change in the real-time consumption signal updates an aggregate requested quantity and causes transmission of an updated digital production instruction or distribution instruction.

14. The method of claim 2, wherein the platform utilizes AI optimization models to determine whether a manufacturer or enterprise has “efficiency or effectiveness” metrics above a threshold score, failing which the system redirects future consumer orders to competing suppliers, and wherein the threshold score is compared with a stored manufacturer efficiency metric and the redirected order is matched to production-capacity data of the competing supplier.

15. The method of claim 2, wherein the platform integrates demand forecasting algorithms to create digital production orders, and wherein each order includes data-driven price points optimized for cost, carbon impact, and consumer preference parameters, includes modules that allow consumers to vote on sustainability preferences, such that the AI prioritizes “green and low-carbon” manufacturers when satisfying demand, and wherein the digital production order specifies a product specification, an aggregate requested quantity, the data-driven price point, the carbon-impact parameter, and the consumer-preference parameter and is transmitted after payment verification.

16. The method of claim 2, wherein the AI engine continuously evaluates macroeconomic, environmental, and logistical conditions to optimize market flow under a “planned economy under a market economy” model, and wherein the macroeconomic, environmental, and logistical conditions are represented by incoming data that updates a production parameter or a distribution parameter.

17. The method of claim 2, wherein the platform facilitates “help the poor and reduce poverty” by reallocating bulk-purchase discounts as credits to low-income users, verified through national identity or income databases, and wherein each reallocated credit is associated with a verified low-income user account and is applied to a price field of an order record.

18. The method of claim 2, wherein the system monitors global inventory and waste indexes across industries, and directs manufacturers to cease or delay production of over-supplied goods to “thoroughly eliminate waste in production and consumption processes”, and wherein the system compares stored inventory data with an aggregate requested quantity and transmits a machine-executed cease or delay instruction when the stored inventory data indicates oversupply.

19. The method of claim 2, wherein AI selects manufacturers with no advertising, sales, marketing, or interest expenses recorded in the system in accordance with “no fixed costs required for advertising, sales, marketing, or even bank interest” to prioritize efficiency, and wherein the recorded expenses are stored with a manufacturer record and are used by the AI Core to rank registered manufacturers.

20. The method of claim 2, wherein the cumulative system effect enables full-cycle replacement of inefficient traditional enterprises by platform-affiliated manufacturers, thus satisfying the transformation goals stated in “replace, consume, and completely eliminate small, medium, large, and even huge enterprises in every industry”, and wherein the full-cycle replacement is implemented by stopping allocation of future order records to a manufacturer having an efficiency metric below a threshold and reallocating the future order records to a registered manufacturer satisfying the threshold.
